(19) United States
(12) Patent Application Publication
(10) Pub. No.: US 2026/0322955 A1
(43) Pub. Date: Oct. 15, 2026

(54) PROJECTOR AND CONTROL METHOD THEREOF

(71) Applicant: SAMSUNG ELECTRONICS CO., LTD., Suwon-si (KR)

(72) Inventors: Dosung JUNG, Suwon-si (KR); Gohwoon Jeong, Suwon-si (KR)

(73) Assignee: SAMSUNG ELECTRONICS CO., LTD., Suwon-si (KR)

(21) Appl. No.: 19/694,191

(22) Filed: Jun. 1, 2026

Related U.S. Application Data
(63) Continuation of application No. PCT/KR2024/018303, filed on Nov. 20, 2024.

(30) Foreign Application Priority Data
Dec. 7, 2023 (KR) 10-2023-0176970

(51) Int. Cl. H04N 9/31; G06F 3/01; H04S 3/00; H04S 7/00

(52) U.S. Cl. CPC H04N 9/3147; G06F 3/011; H04N 9/3155; H04S 3/008; H04S 7/303; H04S 2400/01; H04S 2400/11

(57) ABSTRACT

A projection device includes: a communication interface; a projector configured to project content; a memory storing at least one instruction; and at least one processor operatively connected to the projector, the communication interface, and the memory, wherein the instructions, when executed by the at least one processor individually or collectively, cause the projection device to: based on at least one external device being connected to the projection device through the communication interface, identify a priority among the projection device and the at least one external device based on information regarding a state and performance of the at least one external device, and transmit, to the at least one external device through the communication interface, data corresponding to operation parameters for the at least one external device for an interworking operation with the projection device based on the projection device being identified as a main device based on the priority.

### CROSS-REFERENCE TO RELATED APPLICATIONS

This application is a continuation of International Application No. PCT/KR2024/018303, filed on Nov. 20, 2024, which is based on and claims priority to Korean Patent Application No. 10-2023-0176970, filed on Dec. 7, 2023, in the Korean Intellectual Property Office, the disclosures of which are incorporated by reference herein in their entireties.

### BACKGROUND

### 1. Field

The present disclosure relates to a projector and a control method thereof, and more particularly, to a projector interworking with an external device and a control method thereof.

### 2. Description of Related Art

A projector refers to a device for projecting an image onto a projection surface. The projector is utilized in various manners by projecting an image onto not only a dedicated screen but also various projection surfaces such as an indoor or outdoor wall surface, a floor surface, and a ceiling.

As utilization of projectors increases, a method of projecting a large-screen image or the like by using a plurality of projectors is being attempted. Accordingly, a need is required for a method in which a plurality of projectors interwork with each other.

### SUMMARY

According to an aspect of the disclosure, a projection device includes: a communication interface; a projector configured to project content; a memory storing at least one instruction; and at least one processor operatively connected to the projector, the communication interface, and the memory, wherein the instructions, when executed by the at least one processor individually or collectively, cause the projection device to: based on at least one external device being connected to the projection device through the communication interface, identify a priority among the projection device and the at least one external device based on information regarding a state and performance of the at least one external device, and transmit, to the at least one external device through the communication interface, data corresponding to operation parameters for the at least one external device for an interworking operation with the projection device based on the projection device being identified as a main device based on the priority.

The instructions, when executed by the at least one processor individually or collectively, may cause the projection device to: transmit, to an external device having a projection function among the at least one external device, data corresponding to movement to one side of the projection device and corresponding to projection of an integrated screen interworking with the projection device.

The instructions, when executed by the at least one processor individually or collectively, may cause the projection device to: control the projector to project first content, and transmit, to an external device including a projection function among the at least one external device, data corresponding to projection of additional content related to the first content.

The at least one external device comprises a plurality of external devices, and based on the plurality of external devices including a projection function, the instructions, when executed by the at least one processor individually or collectively, may cause the projection device to: control the projector to project first content, transmit, to at least one external device among the plurality of external devices including the projection function, data corresponding to projection of at least a portion of the first content by interworking with the projection device, and transmit, to remaining devices among the plurality of external devices including the projection function, data corresponding to projection of additional content related to the first content.

Based on content including an audio signal and a video signal being reproduced, the instructions, when executed by the at least one processor individually or collectively, may cause the projection device to: based on an audio output device being included in the at least one external device, transmit, to an external device including the audio output device, data corresponding to movement of the external device including the audio output device to a sound source position of the audio signal and corresponding to output of the audio signal, and transmit, to an external device having a projection function among the at least one external device, data corresponding to movement of the external device having the projection function to one side of the projection device and corresponding to output of at least a portion of the video signal by interworking with the projection device.

The projection device may store, in the memory, information obtained by identifying priority for each function based on information of the projection device and the at least one external device, and based on content including an audio signal and a video signal being reproduced, the instructions, when executed by the at least one processor individually or collectively, may cause the projection device to: identify a device configured to output the audio signal among the projection device and the at least one external device based on priority for an audio output function, and identify a device configured to output the video signal among the projection device and the at least one external device based on priority for a projection function.

The projection device may further include: at least one processor, and the instructions, when executed by the at least one processor individually or collectively, may cause the projection device to: control the projector to project the content, and based on movement of a user being sensed by the at least one sensor while the content is projected, transmit, to an external device having a tracking function and a projection function among the at least one external device, data for projecting the content onto a floor surface along a movement path of the user whose movement is detected.

The instructions, when executed by the at least one processor individually or collectively, may cause the projection device to: based on remaining power of the external device being less than a predetermined value while the external device moves to one side of the projection device and projects the integrated screen based on the transmitted data, transmit, to the external device, data corresponding to a decrease of a light amount of the external device, and control the projector to increase a light amount of the projector, and based on remaining power of the projection device being less than the predetermined value, transmit, to the external device, data corresponding to an increase of a light amount of the external device, and control the projector to decrease the light amount of the projector.

The projection device may further include: an illuminance sensor configured to sense illumiance, and the instructions, when executed by the at least one processor individually or collectively, may cause the projection device to: identify, based on the illuminance and the priority, a number of devices participating in content projection.

The instructions, when executed by the at least one processor individually or collectively, may cause the projection device to: based on the at least one external device being connected to the projection device through the communication interface, store, in the memory, the information regarding the state and performance of the at least one external device.

The data corresponding to operation parameters for the at least one external device may comprise data on position movement and data on projection operation.

According to an aspect of the disclosure, a control method of a projection device includes: based on at least one external device being connected to the projection device, identifying priority among the projection device and the at least one external device based on information regarding a state and performance of the at least one external device; and transmitting, to the at least one external device, data corresponding to operation parameters for the at least one external device for an interworking operation with the projection device based on the projection device being identified as a main device based on the priority.

The control method may further include: transmitting, to an external device having a projection function among the at least one external device, data corresponding to movement to one side of the projection device and corresponding to projection of an integrated screen interworking with the projection device.

The control method may further include: controlling a projector of the projection device to project content; and transmitting, to an external device including a projection function among the at least one external device, data corresponding to projection of additional content related to the content.

The control method may further include: based on a plurality of external devices including the projection function being provided, transmitting, to the at least one external device among the plurality of external devices including the projection function, data corresponding to projection of at least a portion of the content by interworking with the projection device; and transmitting, to remaining devices among the plurality of external devices including the projection function, the data corresponding to projection of the additional content.

The control method may further include: based on content including an audio signal and a video signal being reproduced, based on an audio output device being included in the at least one external device, transmitting, to an external device including the audio output device, data corresponding to movement to a sound source position of the audio signal and corresponding to output of the audio signal; and transmitting, to an external device having a projection function among the at least one external device, data corresponding to movement to one side of the projection device and corresponding to output of at least a portion of the video signal by interworking with the projection device.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an operation of a projector according to one or more embodiments of the present disclosure;

FIG. 2 is a block diagram illustrating a configuration of the projector according to one or more embodiments of the present disclosure;

FIG. 3 is a block diagram illustrating an example of a detailed configuration of the projector according to one or more embodiments of the present disclosure;

FIGS. 4 and 5 are diagrams illustrating the exterior and interior of the projector according to one or more embodiments of the present disclosure;

FIG. 6 is a sequence diagram illustrating an operation of the projector according to one or more embodiments of the present disclosure;

FIG. 7 is a diagram illustrating a method in which the projector identifies a priority for each function according to one or more embodiments of the present disclosure;

FIG. 8 is a diagram illustrating a method in which the projector identifies a priority for each function according to one or more embodiments of the present disclosure;

FIG. 9 is a diagram illustrating a method in which the projector identifies at least one external device to interwork with the projector according to one or more embodiments of the present disclosure;

FIG. 10 is a diagram illustrating a method in which the projector identifies at least one external device to interwork with the projector according to one or more embodiments of the present disclosure;

FIG. 11 is a diagram illustrating a method in which a device group projects two or more images according to one or more embodiments of the present disclosure;

FIG. 12 is a diagram illustrating a method in which a device group projects two or more images according to one or more embodiments of the present disclosure;

FIG. 13 is a diagram illustrating a method in which the projector controls the device group to project an image according to detected illuminance according to one or more embodiments of the present disclosure;

FIG. 14 is a diagram illustrating a method in which the projector controls the device group to project an image according to detected illuminance according to one or more embodiments of the present disclosure;

FIG. 15 is a diagram illustrating map information according to one or more embodiments of the present disclosure;

FIG. 16 is a diagram illustrating a method in which the projector controls projection light amounts of the device group according to one or more embodiments of the present disclosure;

FIG. 17 is a diagram illustrating a method in which the projector controls an audio output direction of the device group according to one or more embodiments of the present disclosure;

FIG. 18 is a diagram illustrating a method in which the projector controls projection light amounts of the device group based on occurrence of a predetermined event according to one or more embodiments of the present disclosure;

FIG. 19 is a diagram illustrating a method in which the projector controls projection light amounts of the device group based on occurrence of a predetermined event according to one or more embodiments of the present disclosure;

FIG. 20 is a diagram illustrating a method in which the projector controls a projector of the device group based on occurrence of a predetermined event according to one or more embodiments of the present disclosure;

FIG. 21 is a diagram illustrating a method in which the projector controls a projector of the device group based on occurrence of a predetermined event according to one or more embodiments of the present disclosure

FIG. 22 is a diagram illustrating a method in which the projector controls a tracking device included in the device group when a change in a user position is detected according to one or more embodiments of the present disclosure;

FIG. 23 is a diagram illustrating a method in which the projector controls a tracking device included in the device group when a change in a user position is detected according to one or more embodiments of the present disclosure;

FIG. 24 is a diagram illustrating a method in which the projector controls another device based on a change in a user position according to one or more embodiments of the present disclosure;

FIG. 25 is a diagram illustrating a method in which the projector controls another device based on a change in a user position according to one or more embodiments of the present disclosure; and

FIG. 26 is a flowchart illustrating a control method of a projector according to one or more embodiments of the present disclosure.

### DETAILED DESCRIPTION

The present disclosure may have various modifications and may have various embodiments, and specific embodiments are illustrated in the drawings and described in detail in the detailed description. However, it should be understood that the scope of the present disclosure is not limited to specific embodiments, and includes various modifications, equivalents, and/or alternatives of the embodiments according to the present disclosure. In the description provided with reference to the drawings, similar reference numerals may be used for similar components.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the disclosure thorough and complete, and are provided to completely convey the spirit of the disclosure to those skilled in the art.

Terms used in the disclosure are used only to describe the specific embodiments rather than limit the scope of the disclosure. A term of a singular number may include its plural number unless explicitly indicated otherwise in the context.

In the present disclosure, the expression such as “have,” “may have,” “include,” or “may include,” indicates the presence of a corresponding feature (e.g., a numerical value, a function, an operation, or a component such as a part), and does not exclude the presence of an additional feature.

In the present disclosure, the expression such as “A or B,” “least one of A and/or B,” or “one or more of A and/or B” may include all possible combinations of items enumerated together. For example, “A or B,” “at least one of A and B,” or “at least one of A or B” may indicate all of 1) a case in which only A is included, 2) a case in which only B is included, or 3) a case in which both of A and B are included.

The expressions such as “first” and “second,” used in the present disclosure, may indicate various components regardless of the sequence and/or importance of the components. These expressions are only used to distinguish one component and another component from each other, and do not limit the corresponding components.

When any component (e.g., a first component) is mentioned to be “(operatively or communicatively) coupled with/to” or “connected to” another component (e.g., a second component), it should be understood that the any component is directly coupled to another component or may be coupled to another component through yet another component (e.g., a third component).

On the other hand, if any component (e.g., the first component) is mentioned to be “directly coupled with/to” or “directly connected to” another component (e.g., the second component), it should be understood that yet another component (e.g., the third component) is not present between any component and another component.

An expression such as “configured (or set) to,” used in the present disclosure, may be replaced by an expression such as “appropriate for,” “having the capacity to,” “designed to,” “adapted to,” “made to,” or “capable of,” depending on a context. The expression “configured (or set) to” does not necessarily indicate “specifically designed to” in terms of hardware.

Instead, the expression “a device configured to,” in any context, may indicate that the device may “perform~” together with another device or component. For example, a “processor configured (or set) to perform A, B, and C” may indicate a dedicated processor (e.g., an embedded processor) that may perform the corresponding operations or a generic-purpose processor (e.g., a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by at least one processor except for a “module” or a “part” that needs to be implemented by specific hardware.

Meanwhile, various elements and regions in the drawings are schematically illustrated. Therefore, the spirit of the present disclosure is not limited by relative sizes or intervals illustrated in the accompanying drawings.

Hereinafter, an embodiment of the disclosure is described in detail with reference to the accompanying drawings so that those skilled in the art to which the disclosure pertains may easily practice the disclosure.

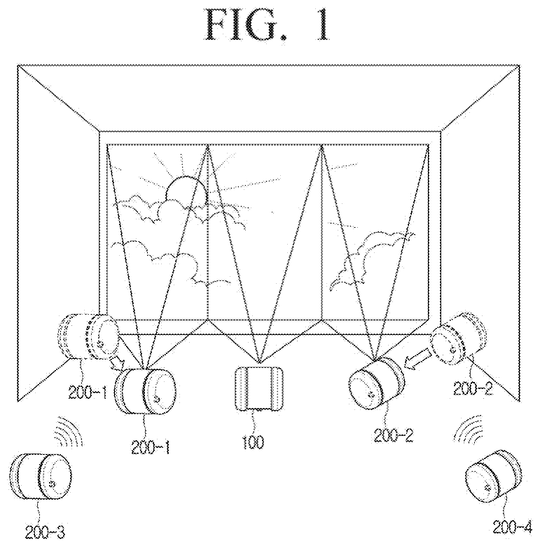

FIG. 1 is a diagram illustrating a projection system according to one or more embodiments of the present disclosure.

Referring to FIG. 1, the projection system according to the present disclosure may include a plurality of electronic apparatuses 100 and 200-1 to 200-4. The electronic apparatuses 100 and 200-1 to 200-4 may be implemented as various apparatuses having a display function or an audio output function. For example, the electronic apparatuses 100 and 200-1 to 200-4 may include various products such as a projector, a speaker, a desktop personal computer (PC), a laptop PC, a mobile phone, a tablet PC, a display device, or a robot cleaner.

In one or more embodiments of the present disclosure, a case in which the projection system includes the projection device 100 (projector 100) and at least one external device 200-1, 200-2, 200-3, or 200-4 is described as a reference. Here, the external device refers to an independent device provided separately from the projector 100, and may be a product of the same type as the projector 100. Alternatively, the external device may be referred to as an electronic apparatus.

When the plurality of electronic apparatuses 100 and 200-1 to 200-4 are connected through a communication network, at least one of the apparatuses may control operations of other apparatuses. For convenience of description, in the present disclosure, a device that controls operations of other devices is referred to as a main device, and another device that operates based on the control is referred to as a sub device. However, the present disclosure is not limited to these terms, and the main device may alternatively be referred to as a master device, a control device, a host device, or the like, and the sub device may alternatively be referred to as a slave device, a controlled device, or the like.

When the projector 100 operates as a main device, the projector 100 may move at least one external device 200-1, 200-2, 200-3, or 200-4 to a position at which at least one external device 200-1, 200-2, 200-3, or 200-4 operates in interworking with the projector 100, and may control at least one external device 200-1, 200-2, 200-3, or 200-4 to reproduce content in interworking with the projector 100.

The projector 100 and at least one external device 200-1, 200-2, 200-3, or 200-4 may be implemented as mobile projectors as illustrated in FIG. 1, and the present disclosure is not limited thereto, and the projector 100 and at least one external device 200-1, 200-2, 200-3, or 200-4 may be implemented as a fixed projector not including a movement function, an aerial projector, a ceiling-mounted projector, or the like. The aerial projector refers to a projector capable of floating and moving in air like a drone, and the ceiling-mounted projector refers to a projector fixed to a ceiling or another wall surface by being attached thereto.

In some embodiments, the projector 100 and at least one external device 200-1, 200-2, 200-3, or 200-4 may be implemented as a user terminal device, a server, an Internet of Things (IoT) hub device, a mobile device, or the like. In this case, the mobile device may be implemented as a device capable of accommodating a projector and moving while the projector is accommodated therein.

The projector 100 and at least one external device 200-1, 200-2, 200-3, or 200-4 may be connected through a communication interface to configure a device group. According to the present disclosure, the device group may provide various multimedia services requested by a user. For example, the device group may provide a content reproduction service such as projecting an image onto a projection surface or outputting audio.

When the device group is configured, devices included in the device group may exchange information regarding the states and performances of the devices with each other. That is, the projector 100 may obtain information regarding the state and performance of at least one external device 200-1, 200-2, 200-3, or 200-4.

Based on the information regarding the states and performances of the devices included in the device group, a main device for controlling the device group among the devices included in the device group may be determined. A method of determining the main device is described again in detail in the following description.

When the projector 100 among the device group is determined as the main device, the projector 100 may control at least one external device 200-1, 200-2, 200-3, or 200-4. In this case, the projector 100 may control the device group to reproduce content based on a user request. Accordingly, the devices included in the device group may interwork to reproduce content. For example, the projector 100 may establish operations parameters for the device group for control of at least one external device 200-1, 200-2, 200-3, or 200-4 accordingly.

For example, the projector 100 may identify, among at least one external device 200-1, 200-2, 200-3, or 200-4, at least one projector 200-1 or 200-2 for projecting a content image and an audio output device 200-3 or 200-4 for outputting content audio. For convenience of description, projectors other than the projector 100, that is, the projectors 200-1 and 200-2, are hereinafter referred to as external projectors.

The audio output device refers to a device capable of outputting audio. For example, the audio output device may be a speaker. However, the present disclosure is not limited thereto, and the audio output device may include a device capable of performing both display and audio output.

The projector 100 may determine a projection position of at least one external projector 200-1 or 200-2 and an audio output position of at least one audio output device 200-3 or 200-4.

The operation parameters may include projection positions and audio output positons for the external devices, and the projection positions and audio output positions may be variously determined according to embodiments. For example, when other projectors 200-1 and 200-2 are included in the external devices, the projector 100 may determine projection positions such that the projectors 200-1 and 200-2 are aligned in parallel at positions spaced apart by a predetermined distance on both sides or in one direction of the projector 100 to implement one large screen. Alternatively, when it is desired to provide various additional contents together, the projector 100 may determine, as projection positions, positions spaced apart from the projector 100 by a predetermined distance. Alternatively, when the projector 100 and the plurality of external projectors 200-1 and 200-2 project the same content screen onto the same region to provide a high-luminance and high-quality image, the projector 100 may determine projection positions such that the projectors are aligned in parallel at positions adjacent to the projector 100. A method of determining the projection positions is described again in detail below together with the drawings.

When the projection position or the audio output position is identified, the projector 100 may control at least one external projector 200-1 or 200-2 to move to an appropriate projection position. In addition, the projector 100 may move at least one audio output device 200-3 or 200-4 to the identified audio output position. Here, when at least one external projector 200-1 or 200-2 or at least one audio output device 200-3 or 200-4 is already positioned at the identified position, an operation of moving at least one external projector 200-1 or 200-2 or at least one audio output device 200-3 or 200-4 by the projector 100 may be omitted.

In addition, the projector 100 may control at least one external projector 200-1 or 200-2 to project an image at the identified projection position, and may control at least one audio output device 200-3 or 200-4 to output audio at the identified audio output position. Specifically, the projector 100 may transmit information regarding the identified position and data corresponding to position movement thereof to each of the external devices 200-1 to 200-4. Here, the data corresponding to the position movement may include a control signal for moving each of the external devices 200-1 to 200-4 to the identified position.

Each of the external devices 200-1 to 200-4 may move to the projection position or the audio output position based on the position information and the control signal received from the projector 100. The projector 100 and each of the external devices 200-1 to 200-4 may identify their own positions in a space in various manners.

For example, the projector 100 and each of the external devices 200-1, 200-2, 200-3, and 200-4 may store map information corresponding to the space and coordinate information corresponding to their own positions in the map. The map information may be shared among the projector 100 and each of the external devices 200-1, 200-2, 200-3, and 200-4. Specifically, at least one of the projector 100 and each of the external devices 200-1, 200-2, 200-3, and 200-4 may directly obtain the map information and the coordinate information by using various sensors such as a light detection and ranging (LiDAR) sensor, an infrared sensor, an image sensor, or the like. When including a LiDAR sensor, each device may irradiate a surrounding space with a laser while moving in the space, receive a reflected signal from the LiDAR sensor, and measure a distance to a surrounding object based on a signal reception time. Each device may obtain a map of the space in which the device is positioned and the coordinate information indicating its current position in the map based on the measured distance. Each device may move to coordinates corresponding to position information designated by the projector 100 based on its current position. The above-described map information may be generated by one of all devices and shared with other devices.

In another example, when at least one of the projector 100 and each of the external devices 200-1, 200-2, 200-3, and 200-4 includes an image sensor, the device may photograph a surrounding space by using the image sensor, analyze the photographed data, and identify a shape of the surrounding space, a distance to a wall, or the like. The device may determine its own position based on the identified information.

In addition, at least one of the projector 100 and each of the external devices 200-1, 200-2, 200-3, and 200-4 may identify overall map information and its own position information based on a user input. As described above, at least one external device may move to a position at which at least one external device operates in interworking with the projector 100 based on a control signal from the projector 100. Accordingly, the projector 100 and at least one external device may provide various services.

Detailed descriptions of the configuration and operation of the projector 100 are provided below with reference to the drawings.

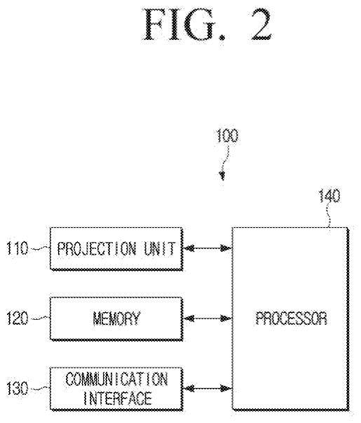

FIG. 2 is a block diagram illustrating a configuration of the projector according to one or more embodiments of the present disclosure.

Referring to FIG. 2, the projector 100 may include a communication interface 130, a projection unit 110, a memory 120, and a processor 140.

The communication interface 130 is a component for performing communication with at least one external device. The communication interface 130 may include at least one wireless communication module or at least one wired communication module. Each communication module may be implemented in a form of at least one hardware chip. The wireless communication module may refer to a module for performing communication with an external device in a wireless manner. For example, the wireless communication module may include at least one of a wireless fidelity (Wi-Fi) module, a Bluetooth module, an infrared communication module, or another communication module. In case of using the Wi-Fi module or the Bluetooth module, the communication interface 130 may first transmit and receive various connection information such as a service set identifier (SSID) or a session key, and connect the communication based on this connection information, and then transmit and receive various information. The infrared communication module may perform communication based on infrared data association (IrDA) technology that wirelessly transmits data in a short distance using an infrared ray between visible light and millimeter waves. In addition, the communication interface 130 may include at least one communication chip that performs communication according to various wireless communication standards such as ZigBee, third generation (3G), third generation partnership project (3GPP), long term evolution (LTE), LTE advanced (LTE-A), fourth generation (4G), and fifth generation (5G). The wired communication module may refer to a module that communicates with an external device in a wired manner. For example, the wired communication module may include at least one of a local area network (LAN) module, an Ethernet module, a pair cable, a coaxial cable, an optical fiber cable, or an ultra wide-band (UWB) module.

The projection unit 110 is a component, such as a projector, for projecting an image outward. According to various embodiments of the present disclosure, the projection unit 110 may be implemented in various projection schemes (e.g., a cathode-ray tube (CRT) scheme, a liquid crystal display (LCD) scheme, a digital light processing (DLP) scheme, or a laser scheme). For example, the CRT scheme may basically use the same principle as a CRT monitor. In the CRT scheme, an image may be displayed on a screen by enlarging an image through a lens in front of a CRT. The CRT scheme may be classified into a single-tube type and a three-tube type based on the number of CRTs, and in the three-tube type, red, green, and blue CRTs may be separately implemented.

In another example, the LCD scheme refers to a scheme of displaying an image by transmitting light emitted from a light source through liquid crystals. The LCD scheme may be classified into a single-panel type and a three-panel type. In the three-panel type, light emitted from the light source may be separated into red, green, and blue by a dichroic mirror (a mirror that reflects only light of a specific color and transmits the rest), transmitted through liquid crystals, and then collected again into one point.

In another example, the digital light processing (DLP) scheme refers to a scheme of displaying an image by using a digital micromirror device (DMD) chip. A projection unit using the DLP scheme may include a light source, a color wheel, a DMD chip, a projection lens, or the like. Light output from the light source may be colored while passing through a rotating color wheel. Light passing through the color wheel may be input to the DMD chip. The DMD chip is a component including a large number of micromirrors. The DMD chip may reflect input light. The projection lens may perform a function of enlarging light reflected from the DMD chip to an image size.

In another example, a projection unit 110 using the laser scheme may include a diode pumped solid state (DPSS) laser and a galvanometer. To output various colors, the DPSS laser may be provided for each of red, green, and blue (RGB) colors. The galvanometer may reflect a laser by rapidly rotating a mirror by using a motor. For example, the galvanometer may rotate the mirror at up to 40 KHz/sec.

Meanwhile, the projection unit 110 may include various types of light sources. For example, the projection unit 110 may include at least one light source of a lamp, a light-emitting diode (LED), or a laser.

The projection unit 110 may output an image in a 4:3 aspect ratio, a 5:4 aspect ratio, or a 16:9 wide aspect ratio based on a purpose of the projector 100, a user setting, or the like, and may output the image having various resolutions such as wide video graphics array (WVGA, 854×480 pixels), super video graphics array (SVGA, 800×600 pixels), extended graphics array (XGA, 1024×768 pixels), wide extended graphics array (WXGA, 1280×720 pixels or 1280×800 pixels), super extended graphics array (SXGA, 1280×1024 pixels), ultra extended graphics array (UXGA, 1600×1200 pixels), full high-definition (full HD, 1920×1080 pixels), and ultra high-definition (UHD, 3840×2160 pixels), based on the aspect ratio.

The projection unit 110 may perform various functions for adjusting an output image under control of the processor 140. For example, the projection unit 110 may perform a zoom function, a keystone function, a quick corner (four-corner) keystone function, a lens shift function, or the like.

Specifically, the projection unit 110 may perform the zoom function of enlarging or reducing an image based on a distance (projection distance) to a screen.

A method of performing the zoom function may be classified into a hardware scheme of adjusting a screen size by moving a lens and a software scheme of adjusting a screen size in software by cropping an image. When the zoom function is performed, focus adjustment of an image is required. The focus adjustment may be performed using a manual focus scheme or a motor-driven scheme. The manual focus scheme refers to a scheme of manually adjusting the focus. The motor-driven scheme refers to a scheme of automatically adjusting the focus by using a motor. The projector 100 may selectively provide a digital zoom function or an optical zoom function.

The projection unit 110 may perform the keystone correction function. When a projection height does not match during front projection, a screen may be distorted upward or downward. The keystone correction function refers to a function of correcting a distorted screen. For example, when distortion occurs in a left-right direction of a screen, the distortion may be corrected by using a horizontal keystone, and when distortion occurs in an up-down direction, the distortion may be corrected by using a vertical keystone. The quick corner (4-corner) keystone correction function refers to a function of correcting a screen when a central region of the screen is normal and a corner region thereof is not balanced. The lens shift function refers to a function of moving a screen as it is when the screen is out of a projection range.

The projection unit 110 may automatically provide the zoom/keystone/focus functions by analyzing a surrounding environment and a projection environment even without a user manipulation. Specifically, the projection unit 110 may automatically provide the zoom/keystone/focus functions based on a distance between the projector 100 and a screen sensed by sensors e.g., a depth camera, a distance sensor, an infrared sensor, or an illuminance sensor), information regarding a space in which the projector 100 is currently positioned, information regarding surrounding light amounts, or the like.

In addition, the projection unit 110 may provide an illumination function by using a light source. In particular, the projection unit 110 may output light by using the light source such as one or more LEDs.

In an embodiment, the projection unit 110 may output a light source by using a surface-emitting LED. The surface-emitting LED refers to an LED having an optical sheet disposed above the LED to uniformly distribute and output light.

The projection unit 110 may provide the user with a dimming function for adjusting an intensity of a light source. Specifically, when the user inputs a command for adjusting an intensity of a light source through various manipulation interfaces such as a touch screen, a button, or a dial, the projection unit 110 may control an LED to output light at an intensity corresponding to the user command. Alternatively, the projection unit 110 may provide the dimming function based on content analyzed by the processor 140 without a user input. Specifically, the projection unit 110 may control an LED to output an intensity of a light source based on information regarding content currently provided (e.g., a content type or content brightness).

The projection unit 110 may control a color temperature under control of the processor 140.

The memory 120 is a component for storing various kinds of software, instructions, data, and the like required for an operation of the projector 100.

Although FIG. 2 illustrates a case in which the memory 120 is implemented as a memory separate from the processor 140, the present disclosure is not limited thereto, and the memory 120 may be implemented as an internal memory such as a read-only memory (ROM) (e.g., an electrically erasable programmable read-only memory (EEPROM)) and a random access memory (RAM) included in the processor 140.

Alternatively, the memory 120 may be implemented as a memory embedded in the projector 100 or a memory detachable from the projector 100 based on a data storage purpose. For example, data for driving the projector 100 may be stored in the memory embedded in the projector 100, and data for an expansion function of the projector 100 may be stored in the memory detachable from the projector 100.

In case of the memory embedded in the projector 100, the memory 120 may be implemented as at least one of a volatile memory (e.g., a dynamic random access memory (DRAM), a static random access memory (SRAM), or a synchronous dynamic RAM (SDRAM)) or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive, or a solid state drive (solid state drive (SSD)).

In case of the memory detachable from the projector 100, the memory 120 may be implemented in a form such as a memory card (e.g., a compact flash (CF), a secure digital (SD), a micro secure digital (Micro-SD), a mini secure digital (Mini-SD), an extreme digital (xD), or a multi-media card (MMC)) and an external memory connectable to a universal serial bus (USB) port (e.g., a USB memory).

As described above, the memory 120 may store not only at least one instruction about the projector 100 but also various software, data, and the like. The memory 120 may store an operating system (O/S) for driving the projector 100. In addition, the memory 120 may store various software programs or applications for allowing the projector 100 to operate according to various embodiments of the present disclosure. The processor 140 may control an operation of the projector 100 by executing various software modules stored in the memory 120. That is, the memory 120 may be accessed by the processor 140, and reading/writing/modifying/deleting/updating of data by the processor 140 may be performed.

In the present disclosure, the term “memory 120” may be used to include a storage, a read-only memory (ROM) in the processor 140, a random access memory (RAM), or a memory card mounted on the projector 100 (e.g., a micro SD card or a memory stick).

The processor 140 is a component for controlling overall operations of the projector 100. The processor 140 may be implemented as a digital signal processor (DSP), a microprocessor, or a time controller (TCON) that processes a digital signal. However, the processor 140 is not limited thereto, and the processor 140 may include or be defined as at least one of a central processing unit (CPU), a micro controller unit (MCU), a micro processing unit (MPU), a controller, an application processor (AP), a graphics-processing unit (GPU), a communication processor (CP), or an advanced reduced instruction set computer (RISC) machines (ARM) processor. In addition, the processor 140 may be implemented as a system-on-chip (SoC) or a large scale integration (LSI) in which a processing algorithm is embedded, or may be implemented in a form of a field programmable gate array (FPGA). In addition, the processor 140 may perform various functions by executing computer executable instructions stored in the memory 120.

In connection with an operation of the projection unit 110, the processor 140 may control a color temperature based on content to be projected. Specifically, when content to be output is identified, the processor 140 may obtain color information for each frame of the content.

The processor 140 may obtain at least one major color of a frame based on the obtained color information for each frame. The processor 140 may adjust the color temperature based on at least one obtained major color. For example, the color temperature adjustable by the processor 140 may be classified into a warm type or a cold type. Here, it is assumed that a frame to be output (hereinafter, an output frame) includes a scene in which a fire occurs. The processor 140 may identify (or obtain) that a major color is red based on color information included in the current output frame. In addition, the processor 140 may identify a color temperature corresponding to the identified major color (red). Here, the color temperature corresponding to red may be the warm type. Meanwhile, the processor 140 may use an artificial intelligence model to obtain the color information or major color of a frame. According to various embodiments, the artificial intelligence model may be stored in the memory 120 or stored in an external server communicable with the projector 100.

When communication is connected to at least one external device through the communication interface 130, the processor 140 may interwork with at least one external device to perform various operations.

Specifically, the processor 140 may receive information regarding the state and performance of at least one external device through the communication interface 130. The processor 140 may store the received information in the memory 120.

The processor 140 may identify a priority among the projector 100 and at least one external device based on the stored information. The priority refers to an order serving as a criterion for determining devices to participate in various services included in various embodiments of the present disclosure. The priority may be set to be classified for each function, or may be set to be classified for each device by integrating various functions. The priority is described again in detail in the following description.

Here, the processor 140 may store information regarding the identified priority in the memory 120. In addition, the processor 140 may identify whether the projector 100 is the main device based on the priority stored in the memory 120.

Specifically, based on the priority, the processor 140 may identify whether the projector 100 is the main device among the projector 100 and at least one external device.

When the processor 140 determines that the projector 100 is not the main device, the processor 140 may perform an operation based on a control signal received from a device set as the main device among at least one external device. For example, when the first external device 200-1, which is one of the external devices 200-1 to 200-4 illustrated in FIG. 1, is the main device, when a control signal for movement to a specific position is received from the first external device 200-1, the processor 140 may move to the position based on the control signal.

The processor 140 may provide various services by controlling at least one external device as the main device when the projector 100 is identified as the main device based on the priority.

For example, the processor 140 may generate data corresponding to position movement at which at least one external device operates in interworking with the projector 100, and may transmit the data to at least one external device through the communication interface 130. The control signal may include position information such as a coordinate value for specifying the position.

As described above, the projector 100 may be implemented in various forms such as a mobile projector, an aerial projector, and a ceiling-mounted projector. When implemented as a mobile projector as illustrated in FIG. 1, the projector 100 may further include various configurations in addition to the configurations illustrated in FIG. 2.

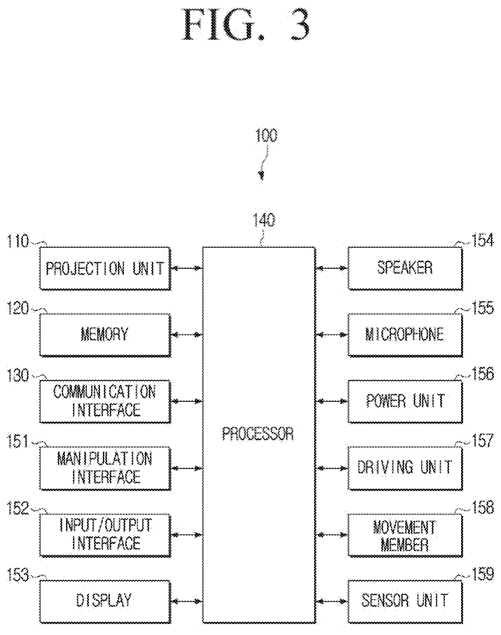

FIG. 3 illustrates an example of a detailed configuration of the projector according to one or more embodiments of the present disclosure.

Referring to FIG. 3, in addition to the communication interface 130, the projection unit 110, the memory 120, and the processor 140, the projector 100 may further include a manipulation interface 151, an input/output interface 152, a display 153, a speaker 154, a microphone 155, a power unit 156, a driving unit 157, a movement member 158, a sensor unit 159, or the like. However, the present disclosure is not limited thereto, and the projector 100 may further include other components, or some of these components may be omitted or changed. Among the components illustrated in FIG. 3, the communication interface 130, the projection unit 110, the memory 120, and the processor 140 are described with reference to FIG. 2, and redundant descriptions thereof are thus omitted.

The manipulation interface 151 is a component for receiving a user manipulation. The manipulation interface 151 may include various types of input devices. For example, the manipulation interface 151 may include a physical button. The physical button may include a function key to which a specific function is matched, a direction key for direction manipulation (e.g., a four-direction key), or a dial button. According to various embodiments, the physical button may be implemented as a plurality of keys. According to another embodiment, the physical button may be implemented as one key. When the physical button is implemented as one key, the processor 140 may receive a user input in which the one key is pressed for less than a threshold time or a user input in which the one key is pressed for greater than or equal to the threshold time. The processor 140 may perform different operations based on a time for which the key is pressed. For example, when pressing for greater than or equal to the threshold time is detected, the processor 140 may turn on or turn off power of the projector 100. When pressing for less than the threshold time is detected, the processor 140 may perform, for example, an operation of turning on or turning off an illumination. A function matched to the key may be variously changed.

The manipulation interface 151 may receive a user input by using a touch scheme. For example, the manipulation interface 151 may receive a user input through a touch sensor or a proximity detection sensor.

The projector 100 may receive a user input in various manners in addition to the above-described manipulation interface 151. According to various embodiments, the projector 100 may receive a user input through an external remote control device. The external remote control device may be a remote control device corresponding to the projector 100 (e.g., a dedicated remote controller of the projector 100) or a portable communication device of a user (e.g., a smartphone or a wearable device). The user may execute an application installed in the portable communication device owned by the user and may input various user commands on an execution screen. The processor 140 may receive the user commands through the communication interface 130 and may perform operations corresponding to the user commands.

Alternatively, the projector 100 may receive a user input by using voice recognition. When the projector 100 includes the microphone 155 as illustrated in FIG. 3 or when the projector 100 may receive an audio signal received from an external microphone through the communication interface 130, the processor 140 may analyze a user voice included in the audio signal received from the microphone 155 or the external microphone and may perform an operation corresponding thereto.

Specifically, the processor 140 may convert an audio signal received from the microphone 155 or the external microphone into a digital signal and may obtain text data by using a speech-to-text (STT) function. The processor 140 may determine whether the obtained text data includes a user command, and when the user command is included, the processor 140 may perform an operation corresponding thereto. A voice recognition process as described above is not necessarily performed directly by the processor 140, and may be performed by an external voice recognition server.

Meanwhile, the projector 100 may receive a user input by using screen interaction. The screen interaction refers to a function in which, when an event such as a user touching one point occurs on an image projected by the projector 100 onto a screen (or a projection surface), the projector 100 performs a control operation corresponding to the event. For example, in a state in which a setting screen including various menus is projected onto a projection surface, when a user selects one menu by using at least one of various objects such as a body part (e.g., a finger), a pointer, or a laser point, the processor 140 may recognize the selected menu and may perform a setting operation corresponding to the menu.

To identify whether the screen interaction occurs, the processor 140 may perform space analysis. For this purpose, the projector 100 may include the sensor unit 159. The sensor unit 159 may include at least one of sensors such as an image sensor, an infrared sensor, a depth camera, or a distance sensor.

The processor 140 may identify whether an event occurs at a specific position (a position on a user interface (UI) screen) by performing the space analysis based on data sensed by the sensor unit 159. When it is identified that an event occurs at the specific position, the projector 100 may perform an operation such as touching the specific position on the UI screen.

The input/output interface 152 is a component for inputting and outputting at least one of an audio signal or an image signal. The input/output interface 152 may receive at least one of an audio signal or an image signal from an external device, and may output a control command to the external device.

In an embodiment, the input/output interface 152 may be implemented as an interface for inputting and outputting only an audio signal, an interface for inputting and outputting only an image signal, or one interface for inputting and outputting both an audio signal and an image signal.

Meanwhile, in various embodiments of the present disclosure, the input/output interface 152 may be implemented as at least one wired input/output interface among a high definition multimedia interface (HDMI), a mobile high-definition link (MHL), a universal serial bus (USB), a USB type-C, a DisplayPort (DP), Thunderbolt, a video graphics array (VGA) port, an RGB port, a D-subminiature (D-SUB), and a digital visual interface (DVI). According to various embodiments, the wired input/output interface may be implemented as an interface for inputting and outputting only an audio signal, an interface for inputting and outputting only an image signal, or one interface for inputting and outputting both an audio signal and an image signal.

In addition, the projector 100 may receive data through a wired input/output interface, which is only one of various embodiments, and power may be supplied through the wired input/output interface. For example, the projector 100 may receive power from an external battery through a USB type-C, or may receive power from an outlet through a power adapter. In another example, the projector 100 may receive power from an external device (e.g., a laptop or a monitor) through a DisplayPort (DP).

Meanwhile, the projector 100 may be implemented in such a manner that an audio signal is received through a wired input/output interface and an image signal is received through a wireless input/output interface (or the communication interface). Alternatively, the projector 100 may be implemented in such a manner that an audio signal is received through a wireless input/output interface (or the communication interface) and an image signal is received through a wired input/output interface. For convenience of description, in FIG. 3, the input/output interface 152 is illustrated separately from the communication interface 130. However, when communication with an external device is performed through the input/output interface 152, the input/output interface 152 may be considered as a component included in the communication interface 130.

The display 153 is a component for displaying an operation state of the projector 100, a notification message, a user interface (UI) screen, or the like. The display 153 may be implemented as various forms of displays such as a liquid crystal display (LCD), an organic light emitting diodes (OLED) display, and a plasma display panel (PDP). The display 153 may also include a driving circuit implemented in a form such as an amorphous silicon thin film transistor (a-si TFT), a low temperature poly silicon (LTPS) TFT, and an organic TFT (OTFT), a backlight unit, or the like. Meanwhile, the display 153 may be implemented as a touch screen combined with a touch sensor, a flexible display, a three-dimensional display (3D display), or the like. Alternatively, the display 153 may be implemented using only one or more light emitting elements. The processor 140 may allow a user to intuitively understand the state of the projector 100 by changing a display state of the display 153 based on various states such as a state in which the projector 100 is in a turned-on state, a state in which a normal operation is performed, and a state in which power is insufficient or an error state occurs.

The speaker 154 is a component for outputting an audio signal. Although FIG. 3 illustrates only the speaker 154, various configurations such as an audio decoder, an audio output mixer, an audio signal processor, and an amplification circuit for processing an audio signal may be further included in the projector 100. The speaker 154 may include one or more speakers, and, when implemented as a plurality of speakers, the plurality of speakers may be symmetrically arranged on an exterior of a body, thereby outputting an audio signal in all directions, that is, 360-degree omnidirectional directions.

The microphone 155 is a component for receiving various audio signals. The microphone 155 may receive a user voice or other sounds and convert the user voice or other sounds into audio data. The microphone 155 may be integrally formed on the upper side, front side, side portion, or the like of the projector 100. The projector 100 may include various components such as an amplifier circuit for amplifying an audio signal received through the microphone 155, an analog-to-digital (A/D) conversion circuit for sampling the amplified audio signal and converting the amplified audio signal into a digital signal, and a filter circuit for removing noise components from the converted digital signal.

The power unit 156 may receive power from an external source and supply power to various components included in the projector 100. According to various embodiments of the present disclosure, the power unit 156 may receive power through various schemes. According to various embodiments, when a charging station for charging is included in an environment as illustrated in FIG. 1, the power unit 156 may receive power through the charging station. Alternatively, the power unit 156 may receive power from an external device, a power source, or the like through various wired or wireless charging schemes.

The power unit 156 may include a battery. For example, when an external power source is connected thereto, the power unit 156 may charge the battery by using an electrical signal applied from the external power source and may supply power to each component included in the projector 100 by using the charged internal battery. Alternatively, the power unit 156 may be implemented to be equipped with a replaceable battery.

The driving unit 157 is a component for moving at least one hardware component included in the projector 100. The driving unit 157 may include at least one motor, and at least one shaft and a gear for transmitting power from the motor to another component, or the like. The driving unit 157 may controlled by the processor 140, and may transmit physical force to each hardware component in the projector 100.

The driving unit 157 may adjust a projection direction (or a projection angle) of the projection unit 110. When the projection unit 110 is rotatably connected to a body of the projector 100, the driving unit 157 may adjust the projection angle by rotating a body part in which the projection unit 110 is installed, or may adjust the projection angle by rotating the body of the projector 100 itself.

In addition, the driving unit 157 may move a position of the projector 100. The driving unit 157 may control the movement member 158 to move the projector 100. For example, the driving unit 157 may control the movement member 158 by using a motor.

The movement member 158 may refer to a member for moving the projector 100. For example, the movement member 158 may include a plurality of wheels, balls, rails, or the like. When the driving unit 157 is driven, rotational power of a motor may be transmitted to the movement member 158 through at least one shaft, and accordingly, the projector 100 may move.

The processor 140 may move to a target position by using the driving unit 157 and the movement member 158.

When an event that requires movement to a specific position in a space occurs, the processor 140 may check map information regarding the space from the memory 120 and set a movement path from a current position to a target position. For example, when it is determined that no obstacle is present on a straight path between the current position and the target position, the processor 140 may determine a movement path extending straight. The processor 140 may control the driving unit 157 and the movement member 158 to move a body of the projector 100 along the determined movement path. When it is determined that an obstacle is present on the straight path between the current position and the target position, the processor 140 may determine an avoidance path avoiding the obstacle. The processor 140 may set the avoidance path by identifying a position of an obstacle in the space based on the map information. The processor 140 may then control the driving unit 157 and the movement member 158 to move the body of the projector 100 along the avoidance path.

The sensor unit 159 may include at least one sensor. Specifically, the sensor unit 159 may include at least one of a tilt sensor for sensing a tilt of the projector 100 or an image sensor for capturing an image. Here, the tilt sensor may refer to an acceleration sensor or a gyro sensor, and the image sensor may refer to a camera or a depth camera. Meanwhile, the tilt sensor may be described as a motion sensor. In addition, the sensor unit 159 may include various sensors in addition to the tilt sensor or the image sensor. For example, the sensor unit 159 may include an illuminance sensor and a distance sensor. The distance sensor may include a time of flight (ToF). In addition, the sensor unit 159 may include a LiDAR sensor.

Meanwhile, the projector 100 may control an illumination function in interworking with an external device. Specifically, the projector 100 may receive illumination information from an external device. Here, the illumination information may include at least one of brightness information or color temperature information set in the external device. Here, the external device may refer to a device connected to the same network as the projector 100 (e.g., an Internet of things (IoT) device included in the same home/company network) or a device (e.g., a remote control server) communicable with the projector 100 although not being in the same network as the projector 100. For example, it is assumed that an external illumination device (IoT device) included in the same network as the projector 100 outputs red illumination at a brightness of 50. The external illumination device (IoT device) may transmit illumination information (e.g., information indicating that red illumination is output at a brightness of 50) to the projector 100 directly or indirectly. Here, the projector 100 may control output of a light source based on the illumination information received from the external illumination device. For example, when the illumination information received from the external illumination device includes the information indicating that red illumination is output at a brightness of 50, the projector 100 may output red illumination at the brightness of 50.

Meanwhile, the projector 100 may control an illumination function based on biometric information. Specifically, the processor 140 may obtain biometric information of a user. Here, the biometric information may include at least one of the body temperature, heart rate, blood pressure, respiration, and electrocardiogram of the user. Here, the biometric information may include various information in addition to the above-described information. For example, the projector 100 may include a sensor for measuring biometric information. The processor 140 may obtain biometric information of a user from the sensor and may control output of a light source based on the obtained biometric information. In another example, the processor 140 may receive biometric information from an external device through the input/output interface 152. Here, the external device may refer to a portable communication device of a user (e.g., a smartphone or a wearable device). The processor 140 may obtain biometric information of a user from the external device and may control output of a light source based on the obtained biometric information. Meanwhile, in an embodiment, the projector 100 may identify whether a user is sleeping, and, when it is identified that the user is sleeping (or preparing for sleep), the processor 140 may control output of a light source based on biometric information of the user.

As described above with reference to FIG. 3, when the projector 100 further includes various components, the projector 100 may provide various smart functions.

Specifically, the projector 100 may be connected to a portable terminal device for controlling the projector 100. The processor 140 may receive a user input that is input from the portable terminal device through the communication interface 130 and may control the projection unit 110 to output a screen corresponding to the user input. For example, the projector 100 may receive screen data that is provided by the portable terminal device from the portable terminal device and output the screen data, and a screen output from the projector 100 may be controlled based on the user input that is input from the portable terminal device.

The projector 100 may share content or music provided from the portable terminal device by being connected to the portable terminal device through various communication schemes such as Miracast, airplay, wireless dalvik executable (DEX), and a remote PC scheme.

In addition, connection between a portable terminal device and the projector 100 may be performed through various connection schemes. According to various embodiments, a portable terminal device may search for the projector 100 to perform wireless connection, or the projector 100 may search for the portable terminal device to perform wireless connection. In addition, the projector 100 may output content provided from the portable terminal device.

According to various embodiments, after a portable terminal device is disposed near the projector 100 in a state in which specific content or music is being output in the portable terminal device, when a predetermined gesture is detected through a display of the portable terminal device (e.g., motion tap view), the projector 100 may output the content or music being output in the portable terminal device.

According to various embodiments, in a state in which specific content or music is being output in the portable terminal device, when the portable terminal device becomes closer to the projector 100 by less than or equal to a predetermined distance (e.g., non-contact tap view) or when the portable terminal device is brought into contact twice with the projector 100 at a short interval (e.g., contact tap view), the projector 100 may output the content or music being output in the portable terminal device.

In the above-described embodiments, it is described that the same screen as a screen included in the portable terminal device is included in the projector 100, and the present disclosure is not limited thereto. That is, when a connection between the portable terminal device and the projector 100 is established, a first screen may be output in the portable terminal device, and a second screen different from the first screen may be output in the projector 100. For example, the first screen may be an execution screen of a first application installed in the portable terminal device, and the second screen may be an execution screen of a second application installed in the portable terminal device. In another example, the first screen and the second screen may be different screens provided by one application installed in the portable terminal device. In another example, the first screen may be a screen including a remote-controller-type user interface (UI) for controlling the second screen. That is, the projector 100 and the portable terminal device may display screens having relevance to each other.

Meanwhile, the projector 100 may output a standby screen when connection to an external device is not performed or when there is no input received from the external device for a predetermined time. Conditions for the projector 100 to output the standby screen are not limited to the above-described examples, and the standby screen may be output according to various conditions.

The projector 100 may output a standby screen in a form of a blue screen, and the present disclosure is not limited thereto. For example, the projector 100 may extract only a shape of a specific object from data received from an external device to obtain an atypical object, and may output a standby screen including the obtained atypical object.

Meanwhile, the projector 100 may further include a shutter unit.

The shutter unit may include at least one of a shutter, a fixing member, a rail, or a body. The shutter may block light output from the projection unit 110. The fixing member may fix a position of the shutter. The rail may be a component for guiding a movement path of the shutter and the fixing member. The body may be a component including the shutter and the fixing member.

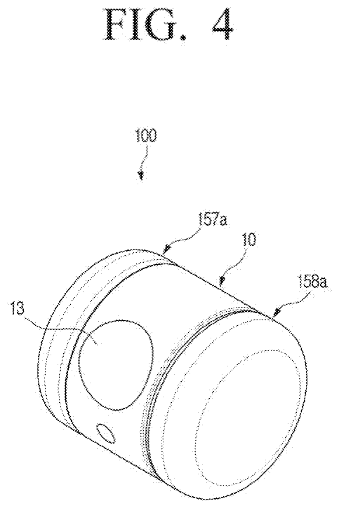

FIG. 4 is a perspective view illustrating an exterior of the projector 100 according to one or more embodiments of the present disclosure.

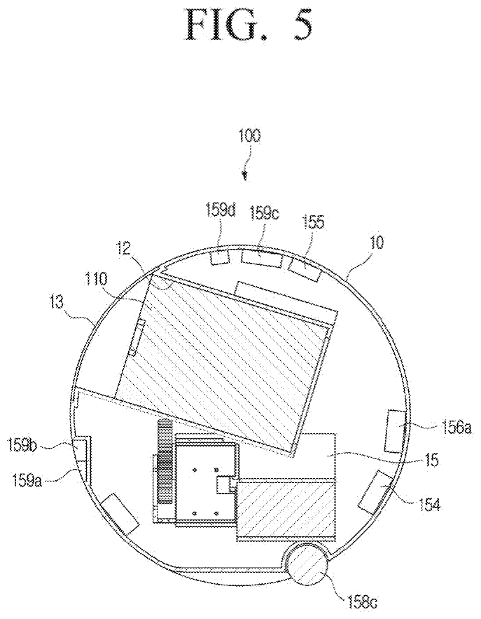

FIG. 5 is a diagram illustrating a cross section of the mobile projector illustrated in FIG. 4.

Referring to FIGS. 4 and 5, the projector 100 according to one or more embodiments of the present disclosure may include a body 10 and movement members 158a and 158b.

The body 10 may form an exterior of the projector 100, and the projection unit 110 and the driving unit 157 may be installed inside the body 10. The body 10 may have a cylindrical shape, and one side surface of the body 10 may be openable and closable.

The body 10 may include the projection unit 110. FIG. 4 illustrates a state in which the projection unit 110 is mounted in a projection unit accommodating portion 12 included in the body 10 and covered by a projection unit cover 13.

The projection unit 110 may be installed in the body 10 to project an image in an upwardly inclined direction with respect to a horizontal plane.

The projection unit cover 13 may be transparently formed to allow light emitted from the projection unit 110 installed in the projection unit accommodating portion 12 to pass therethrough.

The movement members 158a and 158b may be installed on left and right sides of the body 10. FIG. 4 illustrates a case in which the projector 100 includes the left movement member 158a installed on the left side of the body 10 and the right movement member 158b installed on the right side of the body 10. Both the movement members 158a and 158b may have the same shape to be symmetrical to each other.

An auxiliary wheel 158c may be installed on a lower surface of the body 10. The auxiliary wheel 158c may be rotatably installed in a lower-surface groove.

A power unit may be included in the body 10. For example, the power unit may be installed in a base 15. The power unit may be provided as a battery. For example, the power unit may be provided as a rechargeable battery.

Various sensors included in the sensor unit 159 may be installed on an outer circumferential surface of the body 10. FIG. 5 illustrates a state in which a distance sensor 159a, an image sensor 159b, a direction sensor 159c, and an illuminance sensor 159d are installed.

The distance sensor 159a may be implemented as a time of flight (ToF) sensor or a red, green, blue, and depth (RGBD) sensor, and is not limited thereto.

The image sensor 159b may capture an image of surroundings. The image sensor 159b may capture an image of a projection surface onto which the projection unit 110 projects an image.

The direction sensor 159c may detect a direction in which the projection unit 110 faces in the projector 100, that is, a direction of the body 10. The projection unit 110 may be fixed to the body 10, and accordingly, when the direction of the body 10 is identified, the direction of the projection unit 110 may be determined. Accordingly, the processor 140 may detect a direction of the projector 100 based on a sensing value output from the direction sensor 159c. An acceleration sensor, a gyro sensor, a geomagnetic sensor, or the like may be used as the direction sensor 159c.

An illuminance sensor 94 for detecting ambient illuminance may be included in the body 10.

A power switch 156a for turning on/off the projector 100 may be disposed on an outer circumferential surface of the body 10.

The speaker 154 and at least one microphone 155 may be included in the body 10. The speaker 154 and at least one microphone 155 may be installed inside the body 10 to be adjacent to the outer circumferential surface of the body 10.

At least one microphone 155 may be implemented as a directional microphone. At least one microphone 155 may be used for user voice recognition.

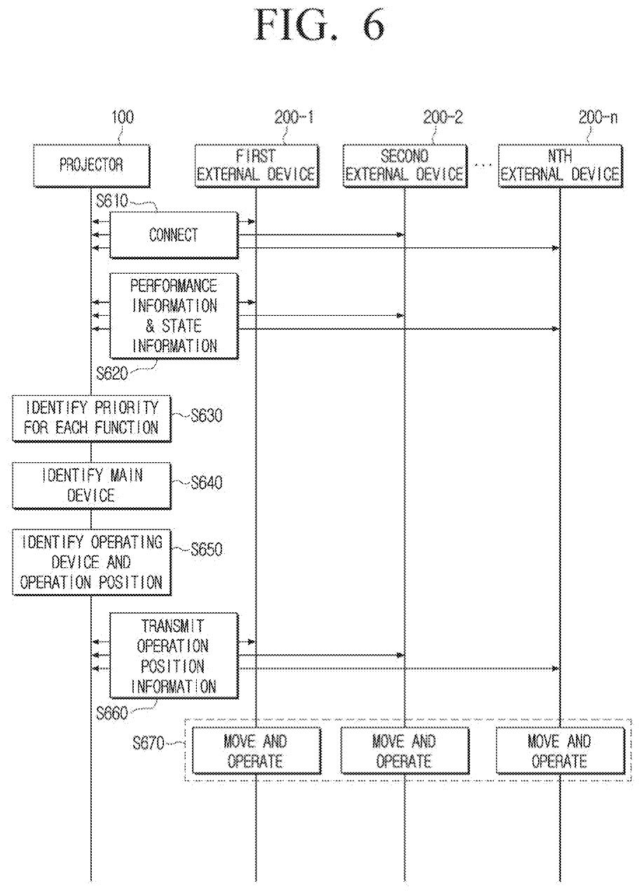

FIG. 6 is a sequence diagram illustrating an operation of the projector according to one or more embodiments of the present disclosure.

Referring to FIG. 6, the projector 100 and at least one external device 200-1, 200-2, . . . , or 200-n may be connected to configure a device group (S610). The projector 100 and at least one external device 200-1, 200-2, . . . , or 200-n may be directly connected through short-range communication such as Bluetooth or Wi-Fi to transmit and receive information. Alternatively, the projector 100 and at least one external device 200-1, 200-2, . . . , or 200-n may be connected through the same access point (AP). Alternatively, the projector 100 and at least one external device 200-1, 200-2, . . . , or 200-n may be indirectly connected through a user terminal device or an external server to transmit and receive information through the user terminal device or the external server.

When the device group is configured, devices included in the device group may transmit and receive the information regarding states and performance of the devices from each other (S620).

Specifically, the projector 100 may transmit the information regarding the performance and state of the projector 100 to at least one external device 200-1, 200-2, . . . , or 200-n. In addition, the projector 100 may receive the information regarding the performance and state of each of at least one external device 200-1, 200-2, . . . , or 200-n. When the information regarding the performance and state of at least one external device 200-1, 200-2, . . . , or 200-n is received, the projector 100 may store the information regarding the performance and state of at least one external device 200-1, 200-2, . . . , or 200-n in the memory 120. The information regarding the performance and state of the projector 100 itself may already be stored in the memory 120. Here, the information regarding the state of the projector 100 may be identified by the processor 140 based on a signal transmitted from each component in the projector 100. For example, the processor 140 may identify the state of the projector 100 itself based on a sensing value obtained from the sensor unit 159.

In the present disclosure, performance information for each function of a device may include information regarding performance required for the device to perform the function. Specifically, the performance information for each function of the device may include information regarding at least one of control performance, projection performance, audio output performance, movement performance, camera performance, or tracking performance of the device.

The control performance of the device may refer to performance required to perform a control function. The control function may refer to a function for a main device to control a device group. Information regarding the control performance of the device may include information regarding at least one of whether an arithmetic device is provided, an arithmetic speed of the arithmetic device, a memory capacity, or a network connection speed, and is not limited thereto.

The projection performance of the device may refer to performance required to perform an image projection function. Information regarding the projection performance of the device may include information regarding at least one of whether a projection function is provided, the maximum resolution of a projected image, the maximum brightness of the projected image, a contrast ratio of the projected image, color reproducibility of the projected image, the maximum projection distance, or a remaining lamp lifespan, and is not limited thereto.

The audio output performance of the device may refer to performance required to perform an audio output function. Information regarding the audio output performance may include information regarding at least one of a volume level characteristic outputtable, whether an audio output function is provided, an audio output channel, or the maximum audio output, and is not limited thereto.

The movement performance of the device may refer to performance required to perform a movement function. Information regarding the movement performance may include information regarding at least one of whether a movement function is provided, a movement speed, whether flying is possible, a rotation speed, or the maximum movement distance, and is not limited thereto.

The camera performance of the device may refer to performance required to capture an image by using a camera. Information regarding the camera performance may include information regarding at least one of whether a camera device is provided, resolution, sensitivity, or a dynamic range, and is not limited thereto.

Information regarding the tracking performance of the device may include information regarding at least one of the movement performance or the camera performance.

In the present disclosure, state information of a device may include information regarding at least one of a position of the device, a power state of the device, a network connection state of the device, or an environment of the device. Here, the device may correspond to the projector 100 or at least one external device 200-1, 200-2, . . . , or 200-n.

Information regarding the position of the device may include information regarding coordinates of a point at which the device is positioned in map information regarding a space in which the device is positioned, and is not limited thereto.

Information regarding the power state of the device may include information regarding at least one of remaining power of the device, an on/off state of the device, a time for which a state in which power of the device is on is maintained, or whether the device is being charged, and is not limited thereto.

The network connection state of the device may include at least one of a network connection bandwidth, a network connection latency, or a network connection signal, and is not limited thereto.

Information regarding the environment of the device may include information regarding environmental variables sensed by a sensor included in the device. For example, information regarding the environment of the device may include information regarding an illuminance value detected by the device, and is not limited thereto.

Based on the state and performance information of devices included in the device group, the projector 100 may identify a priority among devices included in the device group (S630).

According to the identified priority, the projector 100 may identify the main device for controlling the device group among the device group (S640). Here, the main device may refer to a device that integrally controls the device group among the devices included in the device group.

That is, the projector 100 may identify the main device among the projector 100 and at least one external device 200-1, 200-2, . . . , or 200-n. In this case, when the projector 100 is identified as the main device, the projector 100 may control an operation of at least one external device 200-1, 200-2, . . . , or 200-n (S660/S670 of FIG. 6). Although FIG. 6 illustrates a case in which the processor 140 of the projector 100 identifies the projector 100 itself as the main device, this configuration is only an embodiment, and the projector 100 may be identified as the main device by an external device, a user terminal device, or an external server. In this case, the projector 100 may receive, from the external device, the user terminal device, or the external server, information indicating that the projector 100 is identified as the main device.

The projector 100 may determine priority for each function of the devices included in the device group.

The priority for each function may include at least one of a priority for the control function, a priority for the projection function, a priority for the audio output function, a priority for the movement function, and a priority for a tracking function.

Specifically, the priority for the control function may be a priority for determining the main device in the device group.

In addition, the priority for the projection function may be a priority for determining an external projector for performing the projection function. Alternatively, the priority for the projection function may be a priority for determining a method of performing the projection function.

The priority for the audio output function may be a priority for determining an audio output device for performing the audio output function. Alternatively, the priority for the audio output function may be a priority for determining a method of performing the audio output function.

The priority for the movement function may be a priority for determining a movement device for performing the movement function. Alternatively, the priority for the movement function may be a priority for determining a method of performing the movement function.

The priority for a camera function may be a priority for determining a camera capture device for performing a camera capture function. Alternatively, the priority for the camera function may be a priority for determining a method of performing the camera capturing function.

The priority for the tracking function may be a priority for determining a tracking device for performing the tracking function. Alternatively, the priority for the tracking function may be a priority for determining a method of performing the tracking function.

In this case, information serving as a criterion for determining the priority for each function may be the performance information and state information of a device. Specifically, the priority for each function may be determined in such a manner that a device having higher performance required to perform the function has a higher priority. Alternatively, the priority for each function may be determined in such a manner that a device in a state appropriate for performing the function has a higher priority. Alternatively, the priority for each function may be determined in such a manner that a device having higher performance required to perform the function and being in a state appropriate for performing the function has a higher priority.

Specifically, the priority for the control function may be determined to be higher as performance for performing the control function is higher. For example, the priority for the control function may be determined to be higher as an arithmetic speed is higher.

Alternatively, the priority for the control function may be determined in such a manner that a device in a state appropriate for performing the control function has a higher priority. For example, the priority for the control function may be determined to be higher as a network connection speed is higher, as a network connection signal is stronger, as remaining power is higher, as an operation time is longer, as a history in which the device is determined as the main device is greater, and as a time for which a state in which power of the device is turned on is maintained is longer.

The priority for the projection function may be determined in such a manner that a priority of a device having higher projection performance for performing the projection function is higher than a priority of a device having lower projection performance. For example, the priority for the projection function may be determined to be higher as a resolution of a projected image is higher, as brightness of a projectable image is higher, as color reproducibility of a projectable image is higher, and as a projectable projection distance is greater.

Alternatively, the priority for the projection function may be determined in such a manner that a device having a projection function has a higher priority than a device not including the projection function.

Alternatively, the priority for the projection function may be determined in such a manner that a device in a state appropriate for performing the projection function has a higher priority. For example, the priority for the projection function may be determined to be higher as remaining power is higher, as a time for which a state in which power of the device is turned on is maintained is longer, as a remaining lamp lifespan is longer, and as a history in which the device is determined as an external projector is greater.

Meanwhile, the priority for the audio output function may be determined in such a manner that a device having higher audio output performance for performing the audio output function has a higher priority. For example, the priority for the audio output function may be determined to be higher as an audio output channel is higher and as the maximum audio output is higher.

Alternatively, the priority for the audio output function may be determined in such a manner that a device having an audio output function has a higher priority than a device not including the audio output function.

Meanwhile, the priority for the audio output function may be determined in such a manner that a device in a state appropriate for performing the audio output function has a higher priority. For example, the priority for the audio output function may be determined to be higher as remaining power is higher.

The priority for the movement function may be determined in such a manner that a device having higher movement performance for performing the movement function has a higher priority. For example, the priority for the movement function may be determined to be higher as a movement speed is higher, as a rotation speed is higher, and as the maximum movement distance is longer.

Alternatively, the priority for the movement function may be determined in such a manner that a device having a movement function has a higher priority than a device not including the movement function.

Alternatively, the priority for the movement function may be determined in such a manner that a device in a state appropriate for performing the movement function has a higher priority. For example, the priority for the movement function may be determined to be higher as remaining power is higher.

The priority for the camera function may be determined in such a manner that a device having higher camera performance for performing an image capture function has a higher priority. For example, the priority for the camera function may be determined to be higher as camera resolution is higher, as an aperture size is larger, as a lens quality is higher, and when a noise processing function is provided.

Alternatively, the priority for the camera function may be determined in such a manner that a device including a camera has a higher priority than a device not including the camera.

Alternatively, the priority for the camera function may be determined in such a manner that a device in a state appropriate for performing an image capture function has a higher priority. For example, the priority for the camera function may be determined to be higher as remaining power is higher.

Meanwhile, the priority for the tracking function may be determined in such a manner that a device having higher tracking performance for performing the tracking function has a higher priority. For example, the priority for the tracking function may be determined to be higher as a movement speed is higher, as a rotation speed is higher, as the maximum movement distance is greater, and as an arithmetic speed is higher.

Alternatively, the priority for the tracking function may be determined in such a manner that a device having a tracking function has a higher priority than a device not including the tracking function. For example, the priority for the tracking function may be determined in such a manner that a device having a movement function has a higher priority than a device not including the movement function. Alternatively, the priority for the tracking function may be determined in such a manner that a device including a camera has a higher priority than a device not including the camera.

Alternatively, the priority for the tracking function may be determined in such a manner that a device in a state appropriate for performing the tracking function has a higher priority. For example, the priority for the tracking function may be determined to be higher as remaining power is greater, as the device is closer to a user position, and as a history in which the device is determined as the tracking device is greater.

Meanwhile, the priority for each function may be determined based on specific performance or a specific state required to perform the function, which is only an embodiment, and the projector 100 may assign a score to each of performance for each function and a state for each function of a device, and may identify a device having a higher assigned score as a device having a higher priority.

Specifically, the projector 100 may assign a score to each of at least one control performance. Specifically, the projector 100 may assign different scores based on control performances of devices.

For example, assume that a score is assigned to arithmetic speed performance of a device. When an arithmetic speed of an arbitrary device is less than 200 MHz, the processor 140 may assign a score of 0.1. Alternatively, when the arithmetic speed of the device is greater than or equal to 200 MHz and less than 400 MHz, the processor 140 may assign a score of 0.2 to the arithmetic speed performance. Alternatively, when the arithmetic speed of the device is greater than or equal to 400 MHz, the processor 140 may assign a score of 0.3 to the arithmetic speed performance. In this example, a case in which different scores are assigned in units of a range such as 200 MHz is described. However, when a range unit is set to be small such as 1 MHz, a score may be precisely assigned.

In another example, assume that a score is assigned to memory capacity performance. When a memory capacity of a device is less than 500 MB, the processor 140 may assign a score of 0.1. Alternatively, when the memory capacity of the device is greater than or equal to 500 MB and less than 1 GB, the processor 140 may assign a score of 0.2 to the memory capacity performance. Alternatively, when the memory capacity is greater than or equal to 1 GB, the processor 140 may assign a score of 0.3 to the memory capacity performance.

The processor 140 may identify a priority of a device having a higher score for one control performance among the control performances to be higher. Alternatively, the processor 140 may identify a priority of a device having a higher value obtained by summing scores of each of at least one control performance to be higher. Alternatively, the processor 140 may assign a weight to a score of each of at least one control performance, and may identify a priority of a device having a higher value obtained by summing weighted scores to be higher.

The processor 140 may identify a priority of a device in a state more appropriate for performing the control function to be higher.

The processor 140 may assign a score to each state of at least one device. Specifically, when a value indicating a first state of a device is a first value, the processor 140 may assign a first score to the first state of the device. When the value indicating the first state of the device is a second value higher than the first value, the processor 140 may assign a second score higher than the first score to the first state of the device.

For example, when remaining power of a device is less than 30%, the processor 140 may assign a score of 0.1 to remaining power of the device. In addition, when remaining power of the device is greater than or equal to 30% and less than 60%, the processor 140 may assign a score of 0.2 to remaining power of the device. In addition, when remaining power is greater than or equal to 60%, the processor 140 may assign a score of 0.3 to remaining power of the device.

For example, when a history in which a device is determined as a main device is less than two times, the processor 140 may assign a score of 0.1 to the history in which the device is determined as the main device. When the history in which the device is determined as the main device is greater than or equal to two times and less than four times, the processor 140 may assign a score of 0.2 to the history in which the device is determined as the main device. In addition, when the history in which the device is determined as the main device is greater than or equal to four times, the processor 140 may assign a score of 0.3 to the history in which the device is determined as the main device.

For example, when a network connection speed of a device is less than or equal to 10 Mbps, the processor 140 may assign a score of 0.1 to the network connection speed of the device. Alternatively, when the network connection speed of the device is greater than or equal to 10 Mbps and less than 50 Mbps, the processor 140 may assign a score of 0.2 to the network connection speed of the device. Alternatively, when the network connection speed of the device is greater than or equal to 50 Mbps, the processor 140 may assign a score of 0.3 to the network connection speed of the device.

The processor 140 may identify a priority of a device having a higher score for the first state to be higher. Alternatively, the processor 140 may identify a priority of a device having a higher value obtained by summing scores for each of at least one state to be higher. Alternatively, the processor 140 may assign a weight to a score for each of at least one state, and may identify a priority of a device having a higher value obtained by summing weighted scores to be higher.

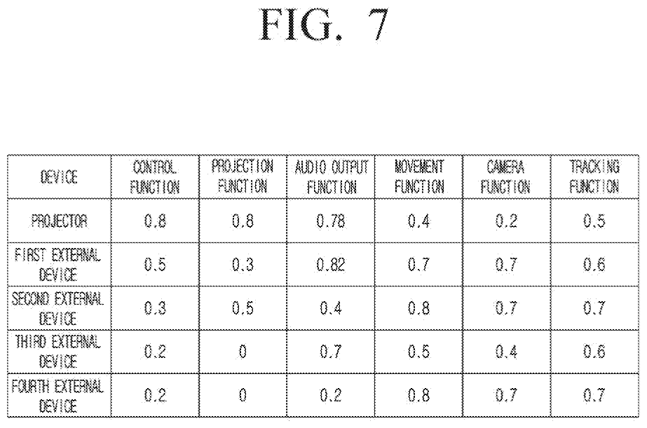

Accordingly, a score for each function of each device included in the device group may be calculated as illustrated in FIG. 7.

Alternatively, the processor 140 may identify a priority of a device having a higher value obtained by summing a score for each of at least one control performance and a score for each state for performing at least one control function to be higher. Alternatively, the processor 140 may identify a priority of a device having a higher value obtained by summing a score for each of at least one control performance and a score for each state for performing at least one control function to be higher.

Alternatively, the processor 140 may classify each of at least one control performance into a specific category (e.g., high, medium, or low) or a specific level (e.g., Level 1, Level 2, or Level 3). Specifically, when a first control performance corresponds to a first value, the projector 100 may classify the first control performance into a first category or a first level. In addition, when the first control performance corresponds to a second value higher than the first value, the projector 100 may classify the first control performance into a second category or a second level. In this case, the processor 140 may identify a priority of a device in which control performance is classified into the second category or the second level to be higher than a priority of a device in which control performance is classified into the first category or the first level.

Similarly, the processor 140 may classify each state for performing at least one control function into a specific category or a specific level. Specifically, when a first state corresponds to a first value, the processor 140 may classify the first state into a first category or a first level. In addition, when the first state corresponds to a second value higher than the first value, the processor 140 may classify the first state into a second category or a second level. In this case, the processor 140 may identify a priority of a device, in which control performance is classified into the second category or the second level, to be higher than a priority of a device, in which control performance is classified into the first category or the first level.

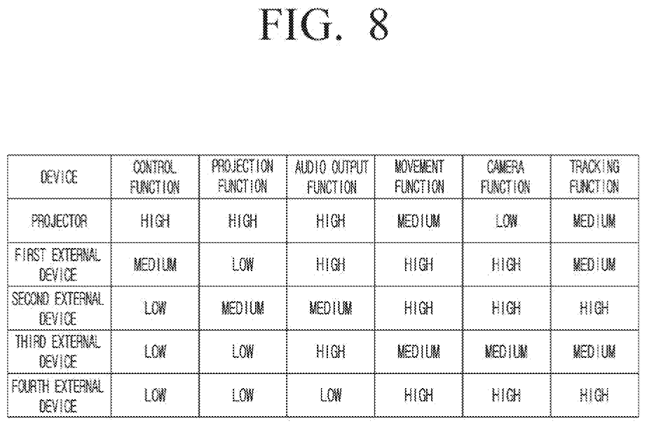

Accordingly, a category or a level for each function of each device included in the device group may be classified as illustrated in FIG. 8. FIG. 7 illustrates data in which a score for each function of each device is specifically recorded, and FIG. 8 illustrates data in which a category for each function of each device is recorded in stages such as high, medium, and low, rather than in score units.

The processor 140 may identify a priority of a device having a higher value obtained by summing values (e.g., a first category corresponds to 0.1 and a second category corresponds to 0.2) corresponding to a category or a level for each of at least one control performance to be higher. Alternatively, the processor 140 may identify a priority of a device having a higher value obtained by summing values corresponding to a category or a level for each of states for performing at least one control function to be higher. Alternatively, the processor 140 may identify a priority of a device having a higher value obtained by summing values corresponding to a category or a level for each of at least one control performance and values corresponding to a category or a level for each of at least one control function to be higher. Alternatively, the processor 140 may assign a weight to a value corresponding to a category or a level for at least one control performance, may assign a weight to a value corresponding to a category or a level for each state for performing at least one control function, and may identify a priority of a device having a higher value obtained by summing weighted values to be higher.

According to the above-described method, the processor 140 may identify a priority for the projection function, a priority for the audio output function, a priority for the movement function, a priority for the camera function, and a priority for the tracking function.

When priority for each function is identified, the processor 140 may determine the main device in the device group based on a priority for the control function. In this case, the projector 100 may determine, as the main device in the device group, a device having a highest priority for the control function.

When the projector 100 is determined as the main device, the processor 140 may control the device group in such a manner that the devices in the device group interworks to reproduce content.

Specifically, when priority for each function of each device included in the device group is identified, the processor 140 may identify at least one external device, an operation position, and an operating operation for performing an operation for reproducing content (S650). In this case, at least identified one external device may interwork and perform the operation for reproducing content.

Meanwhile, the external device, the operation position, and the operating operation may be identified based on at least one of priority for each function, reproduced content, or a content reproduction environment.

The external device may be a device performing an operation for reproducing content in the device group. In this case, the external device may be selected as a projector for projecting a content image, an audio output device for outputting a content voice, or a movement device for performing a movement operation, and is not limited thereto.

Based on the priority for each function, the reproduced content, or the content reproduction environment, the processor 140 may identify the number of external devices interworking with the projector 100. When the number of external devices is identified based on at least one of the priority for each function, the reproduced content, or the content reproduction environment, the processor 140 may identify at least one operating device in an order of higher priority for a function required to reproduce content.

Specifically, the reproduced content may be content including a video signal. In this case, when the content is a large-screen image or a high-quality image, a plurality of projectors may be required to project a content screen onto a projection surface. In this case, each of the plurality of projectors may divide and project the large-screen image or the high-quality image. Accordingly, images projected by the plurality of projectors may form an integrated screen.

The processor 140 may identify the number of external devices, that is, the number of external projectors, for projecting an image, based on the size and image resolution. In this case, the identified number of external projectors may increase as the image size increases. Alternatively, the number of external projectors may increase as the image resolution increases. That is, the number of external projectors may correspond to at least one of the size and image resolution.

For example, when an image resolution corresponds to FHD, the processor 140 may identify the number of projectors for projecting the image as one projector. Alternatively, when the image resolution corresponds to UHD, the processor 140 may identify the number of projectors for projecting the image as three projectors. Alternatively, when a size of a projected image is 40 inches, the processor 140 may identify the number of projectors for projecting the image as one projector. Alternatively, when the size of the projected image is 100 inches, the processor 140 may identify the number of projectors for projecting the image as three projectors.

Accordingly, when content corresponds to content including a video signal, the processor 140 may identify, in the device group, the number of projectors corresponding to the image in an order of higher priority for the projection function among the devices including the projection function.

For example, when the number of projectors is identified as three projectors, the processor 140 may identify three projectors in the device group in an order of higher priority for the projection function. In this case, the processor 140 may determine whether the projector 100 itself participates in the projection function based on the priority. For example, when the processor 140 determines that a priority for the projection function of the projector 100 is lower than priorities for the projection function of other external projectors, the processor 140 may select all three projectors among the external devices. However, the present disclosure is not limited thereto, and, according to another embodiment, the processor 140 may control the projector 100 itself to unconditionally participate in the projection function regardless of the priority. In this case, the processor 140 may additionally select only two external projectors among the external devices. Accordingly, a total of three projectors including the projector 100 may perform the projection function together.

Hereinafter, various services provided by the projector 100 by interworking with at least one external device are described in detail.

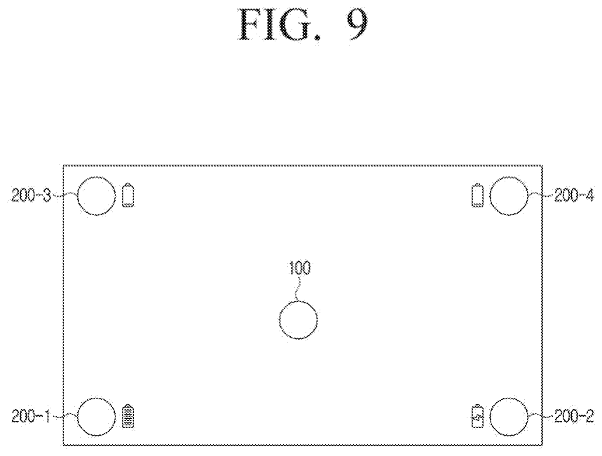

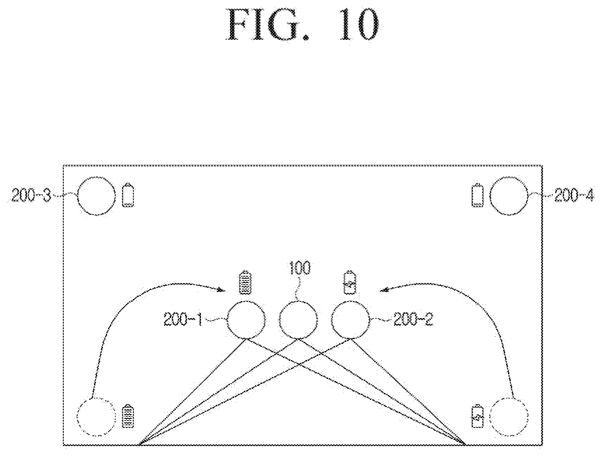

FIGS. 9 and 10 are diagrams illustrating a method in which the projector 100 identifies at least one external device to interwork with the projector 100 according to one or more embodiments of the present disclosure.

Referring to FIG. 9, the projector 100 and at least one external device 200-1, 200-2, 200-3, or 200-4 may configure one device group. Referring to FIG. 9, remaining power of the projector 100 and the first external device 200-1 may be 90% or more, remaining power of the second external device 200-2 may be 100%, remaining power of the third external device 200-3 may be less than 10%, and remaining power of the fourth external device 200-4 may be less than 5%.

In this case, the processor 140 may identify, as three devices having higher priority for the projection function in the device group, the projector 100, the first external device 200-1, and the second external device 200-2.

When the number of projectors required to project a content image is three projectors, the processor 140 may control the projector 100, the first external device 200-1, and the second external device 200-2 to interwork to project an image, as illustrated in FIG. 10. That is, the processor 140 may control the driving unit 157 and the movement member 158 to move the body of the projector 100 itself to a projection position, and may transmit, to the first external device 200-1 and the second external device 200-2, data corresponding to movement to one side of the projector 100. Here, the data corresponding to movement to one side of the projector 100 may include a control signal for movement to one side of the projector 100. The control signal may include coordinate information regarding a position at which the first external device 200-1 and the second external device 200-2 are respectively positioned.

The first external device 200-1 and the second external device 200-2 may move around the projector 100 based on the control signal and may project an image onto the projection surface.

The projected image may include two or more contents. The content may include multimedia content including both an audio signal and a video signal, video content including only the video signal, audio content including only the audio signal, Internet content, an application execution screen, a document, file directory screen content, or the like. When at least one external projector having the projection function interworks with the projector 100, the processor 140 may control the projection unit 110 and at least one external projector in such a manner that one content is projected together onto the same region, one content is divided and projected into respective projection regions, or a plurality of contents are respectively projected.

When the plurality of contents are projected, one of the plurality of contents may be main content, and the others may be additional content.

The additional content may be an information screen related to the main content. For example, when the main content is multimedia content such as a movie or a drama, the additional content may be a search result screen about a person or a product included in the main content. Alternatively, when the main content is a sports game broadcast screen, the additional content may be score information, information regarding a team or a player participating in the sports game, records of previous games, a highlight image, and game analysis content.

The projector 100 may identify the number of projectors for outputting the main content and the number of projectors for outputting the additional content.

That is, when external devices having the projection function are a plurality of external devices, the processor 140 may transmit, to at least one of the plurality of external devices having the projection function, data corresponding to projection of at least a portion of the main content by interworking with the projector 100. In addition, the processor 140 may transmit, to remaining devices among the plurality of external devices having the projection function, data corresponding to projection of the additional content.

A method of identifying the number of projectors for outputting the main content and a method of identifying the number of projectors for outputting the additional content are described above, and redundant descriptions are thus omitted.

When the plurality of external devices having the projection function interwork together with the projector 100, the processor 140 may generate a control signal for allowing at least one of the plurality of external devices to interwork with the projector 100 to project at least a portion of the content, and transmit the control signal to the corresponding external device. The processor 140 may generate data corresponding to additional content projection related to the content projected by the projector 100 and may transmit the data to remaining devices among the plurality of external devices. Here, the data corresponding to additional content projection may include a control signal for projecting the additional content. In the present disclosure, for convenience of description, the content projected by the projector 100 may be referred to as the main content, and the present disclosure is not limited thereto.

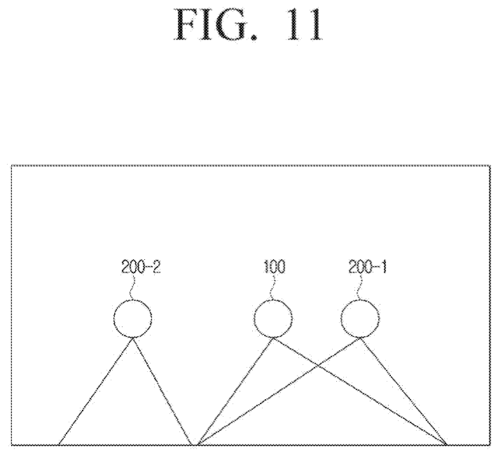

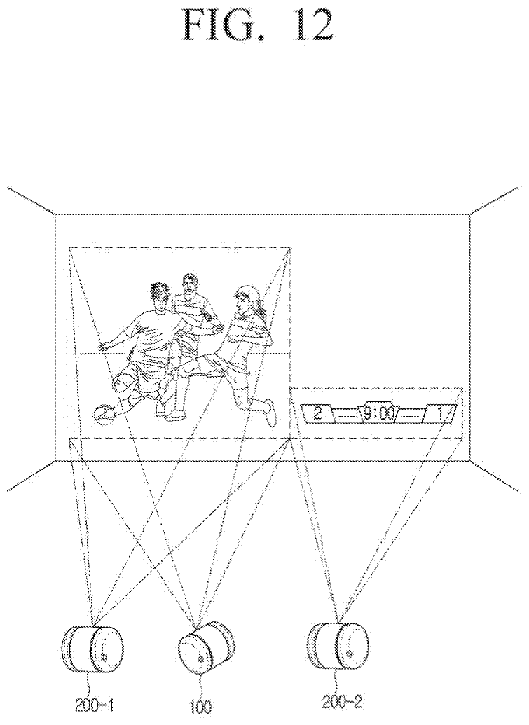

FIGS. 11 and 12 are diagrams illustrating a method in which the device group projects two or more contents according to one or more embodiments of the present disclosure.

Referring to FIGS. 11 and 12, the processor 140 may control the projector 100 and the first external device 200-1 to interwork to project main content 710, and may control the second external device 200-2 to project additional content 720.

For example, as illustrated in FIG. 12, the main content 710 may be a sports game image, and the additional content 720 may be score information of the sports game.

The processor 140 may determine both the main content and the additional content based on a user selection. Alternatively, when the main content is determined based on the user selection, the processor 140 may arbitrarily determine the additional content.

For example, when a user inputs a search word “soccer game of team A,” the processor 140 may select a broadcast screen of the soccer game of team A as the main content and may select various search results based on the search word “team A” as the additional content. When the main content and the additional content are respectively determined, the processor 140 may directly provide, to the first external device 200-1 and the second external device 200-2, data regarding each content (e.g., a video stream). However, the present disclosure is not limited thereto, and the processor 140 may provide, to the first external device 200-1 and the second external device 200-2, source information (e.g., a uniform resource locator (URL) or a broadcast channel number) regarding content to be output from the first external device 200-1 and the second external device 200-2. Alternatively, the processor 140 may provide, to the first external device 200-1 and the second external device 200-2, identification information for identifying the main content and sub content selected by the user and information regarding the sub content, thereby allowing each external device to directly search for and output the content.

Meanwhile, the external device for reproducing the additional content according to the above description may be the projector as described above. However, the present disclosure is not limited thereto, and the external device for reproducing the additional content may be a display device. In this case, the display device may be implemented in various forms such as the user terminal device including a display, a TV, a smartphone, and a projector. In addition, the display device may display the additional content on the display.

Specifically, the processor 140 may control the projector 100 to project the main content and may control the display device to display the additional content. In this case, the projector 100 may transmit, to the display device, information for displaying the additional content. Here, the information for displaying the additional content may include data regarding content to be output or source information regarding content to be output.

In this case, the display device for reproducing the additional content may be predetermined. However, the present disclosure is not limited thereto, and the processor 140 may receive, from the display device, an additional-content display request signal.

In this case, when the additional-content display request signal is received from the display device, the processor 140 may transmit, to the display device, the information for displaying the additional content.

Meanwhile, the projector 100 may project the main content and the display device may display the additional content. However, the present disclosure is not limited thereto, and the processor 140 may control an external device to project the main content or may control the projector 100 to display the additional content.

Specifically, the processor 140 may control at least one external projector to project the main content and may control the display device to display the additional content. Alternatively, the projector 100 may control at least one external projector to project the main content and may control the display 153 to display the additional content.

Meanwhile, the reproduced content may be content including a video signal and an audio signal. For an external device having the projection function among at least one external device, the processor 140 may transmit a control signal for movement to one side of the projector 100 and interwork with the projector 100 to output at least a portion of the video signal. In this case, when a priority for the projection function is identified and stored in the memory 120, the processor 140 may identify an external projector based on the priority.

Meanwhile, the processor 140 may check whether at least one external device includes an audio output device. When at least one external device includes a plurality of audio output devices, the processor 140 may identify the number of audio output devices for outputting the audio signal based on a channel of the audio signal. In this case, the number of audio output devices may increase as an output channel of the audio signal increases. That is, the number of audio output devices may correspond to the channel of the audio signal.

For example, when an output channel of the audio signal is four channels, the projector 100 may identify the number of audio output devices for outputting the audio signal as four devices. In addition, when the output channel of the audio signal is two channels, the projector 100 may identify the number of audio output devices for outputting the audio signal as two devices.

When the number of audio output devices is less than the number of audio output channels, the processor 140 may identify an audio output device capable of outputting the audio signal at a position (e.g., left and right or left rear and right rear) capable of maximizing an audio listening effect.

For the identified audio output device, the processor 140 may transmit a control signal for movement to a sound-source position of the audio signal to output the audio signal. For example, when the number of audio output devices is two devices, the processor 140 transmits, to each external device, that is, each audio output device, a control signal for movement to the left side and right side of the user to output a left surround audio signal and a right surround audio signal, respectively.

The processor 140 may identify at least one audio output device in an order of higher priority for the audio output function in the device group.

Meanwhile, the content reproduction environment may include information regarding illuminance of a content reproduction space. In this case, the illuminance of the content reproduction space may be sensed by an illuminance sensor included in the sensor unit 159 of the projector 100.

The processor 140 may determine the number of projectors for projecting an image based on the detected illuminance. When the illuminance is low, a brightness value required for a user to watch a projected image may increase. Accordingly, as the detected illuminance decreases, the number of projectors for projecting an image may increase. That is, the processor 140 may identify the number of projectors for projecting an image according to the detected illuminance.

In this case, when the detected illuminance is a first illuminance, the processor 140 may identify the number of projectors for projecting an image as n1 projectors. In addition, when the detected illuminance is a second illuminance, the processor 140 may identify the number of projectors for projecting an image as n2 projectors. Assuming that the second illuminance is greater than the first illuminance, n2 may be set to be greater than n1. The processor 140 may identify the number of devices to participate in content projection based on the priority. That is, when the number of projectors is identified as n2 projectors, the processor 140 may determine that n2 projectors in order of higher priority among all projectors in the device group participate in content projection.

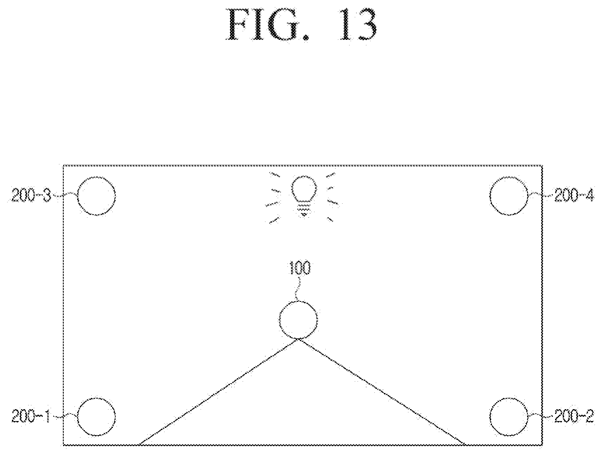

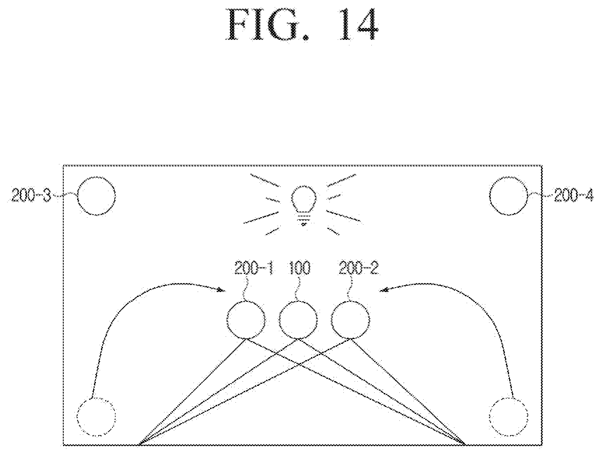

FIGS. 13 and 14 are diagrams illustrating a method in which the projector 100 controls each device according to the detected illuminance according to one or more embodiments of the present disclosure.

For example, referring to FIG. 13, when the illuminance sensed by the illuminance sensor is the first illuminance (e.g., 5 lux), the processor 140 may identify the number of projectors for projecting an image as one projector. Accordingly, the processor 140 may identify that, in the device group (including the devices 100, 200-1, 200-2, 200-3, and 200-4), the projector 100 having the highest priority for the projection function projects the content. Accordingly, the processor 140 may control the driving unit and the movement member to move to a determined position and control the projection unit 110 to project the content at the corresponding position.

FIG. 14 illustrates a case in which the illuminance detected by the processor 140 becomes greater. For example, when a second illuminance (e.g., 30 lux) is sensed, it may be necessary to increase luminance to increase identifiability of content. When a change in illuminance in the environment from the first illuminance to the second illuminance is detected, the processor 140 may identify the number of projectors for projecting an image as three projectors. Accordingly, the processor 140 may control three devices 100, 200-1, and 200-2 in an order of higher priority for the projection function in the device group (including the devices 100, 200-1, 200-2, 200-3, and 200-4) to project an image. The projector 100 may currently project an image, and accordingly, the processor 140 may additionally transmit, to the first and second external devices 200-1 and 200-2, a control signal for movement to a side of the projector 100 to project an image.

As described above, when the number of projectors for projecting an image is identified, the projector 100 may identify, as at least one projector, the number of devices corresponding to the identified number in an order of higher priority for the projection function.

The processor 140 may determine positions of the projector 100 and the external projectors based on the number and size of contents to be displayed together with the external projectors, ambient illuminance, a size of a projection surface, a position of the projection surface, or the like.

For example, when one content is to be displayed by being superimposed on the same region in the projection surface to increase luminance, the processor 140 may control the driving unit and the movement member to allow the projector 100 to be positioned at a point between the projection surface and the user position and spaced apart from the projection surface by an appropriate distance, in consideration of a horizontal/vertical size of the content, the user position, and the position of the projection surface. When the position of the projector 100 is determined, the processor 140 may transmit, to at least one external projector, data corresponding to content projection onto the same region by moving to a position adjacent to both sides or one side of the projector 100.

In another example, when one content is to be expressed as a wider screen, the processor 140 may first determine the position of the projector 100 in consideration of the horizontal/vertical size of the content, the user position, and the position of the projection surface. After determining external projectors that project the divided images in a state in which an image of the content is divided into a plurality of divided images, the processor 140 may set projection positions of the external projectors to positions spaced apart from the projector 100 by a predetermined distance or more. The processor 140 may determine, as the projection positions of the external projectors, positions in which the divided images are connected to each other on the projection surface to form an integrated screen. The processor 140 may determine the projection positions in consideration of a wide angle of the projection unit 110 and each external projector. The processor 140 may transmit, to each external projector, data corresponding to determined projection position movement through the communication interface 130.

That is, for an external device having the projection function among at least one external device, the processor 140 may transmit, to the external device having the projection function, data corresponding to projection of an integrated screen by interworking with the projector 100 while the external device having the projection function moves to one side of the projector 100. Specifically, the processor 140 may generate a control signal for movement to one side of the projector 100 to project an integrated screen by interworking with the projector 100, and transmit the generated control signal to the external device.

In another example, when one main content and at least one additional content are to be displayed, the processor 140 may first identify and distinguish a device for displaying the main content from a device for displaying the additional content among the projector 100 and external projectors 200-1 and 200-2, and may transmit a control signal for allowing devices for displaying the main content to be positioned together within a distance in which images are connectable, and devices for displaying the additional content to be spaced apart from the devices for displaying the main content by a predetermined distance or more. That is, the processor 140 may control the movement to each of positions illustrated in FIGS. 11 and 12.

In addition, when the number of audio output devices for outputting audio is identified, the projector 100 may identify, as at least one audio output device, devices corresponding in number to the identified number in an order of higher priority for the audio output function.

When at least one external device (e.g., the projector or the audio output device) interworking with the projector 100 is identified, the processor 140 may identify an operation position of each external device.

Specifically, when at least one external projector is identified, the processor 140 may identify a projection position at which at least one external projector projects an image.

In addition, when at least one audio output device is identified, the processor 140 may identify a sound-source position for at least one audio output device to output audio. As described above, the audio output position may be determined based on the number of audio output channels. For example, in a case of 5.1 channels, the processor 140 may determine a total of five sound-source positions such as a front of the user, a left front of the user, a right front of the user, a left rear of the user, and a right rear of the user, and may transmit, to at least one audio output device, a control signal including position information (e.g., coordinate values) regarding each sound-source position.

As described above, for position specification and synchronization, the memory 120 may store map information regarding a space in which the projector 100 is positioned. In this case, the map information may include at least one of information regarding positions of walls in the space in which the projector 100 is positioned, information regarding a position of an obstacle, information regarding a projection surface, and information regarding positions of devices included in the device group. In this case, the map information may be information generated based on information sensed by the sensor unit 159 included in the projector 100. When generating the map information, the processor 140 may share the map information with at least one external device through the communication interface 130. Alternatively, the processor 140 may receive map information from at least one external device and store the map information in the memory 120.

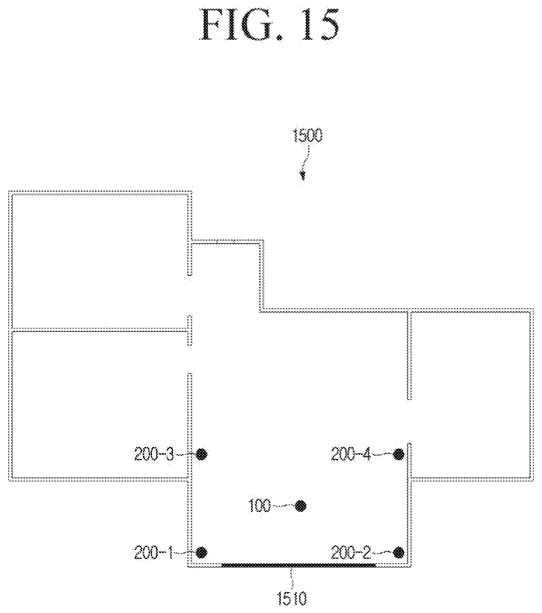

FIG. 15 is a diagram illustrating map information according to one or more embodiments of the present disclosure.

Referring to FIG. 15, map information 1500 may store wall information of a space in which the device group (including the devices 100, 200-1, 200-2, 200-3, and 200-4) is positioned, information regarding a position of an obstacle, information regarding a projection surface 1510, and information regarding a position of each device included in the device group (i.e., the device 100, 200-1, 200-2, 200-3, or 200-4).

In this case, based on the map information stored in the memory 120, the processor 140 may identify an operation position of at least one external device and an operation position of the projector. In this case, the number of identified operation positions may be the same as the number of devices participating in the projection function.

When the processor 140 determines that only the projector 100 performs projection, the processor 140 may identify a projection surface and may identify a projection position based on a position of the identified projection surface.

Specifically, the processor 140 may identify a wall surface or a screen around the projector 100 as a projection surface based on an image around the projector 100 obtained from the image sensor. In addition, based on the map information stored in the memory 120 and information regarding the identified projection surface, the processor 140 may identify an operation position of the external device. In this case, the operation position of at least one external device may be identified as one side (e.g., the left side or right side) of the projector 100.

Meanwhile, when at least one external device is an audio output device, the processor 140 may identify an audio output position for outputting audio. In this case, the processor 140 may identify a sound-source position of an audio signal as the audio output position.

Specifically, the processor 140 may identify a user position based on an image around the projector 100 obtained from the image sensor. When the user position is identified, the projector 100 may identify a sound-source position of the audio signal as the audio output position based on the identified user position.

For example, when an output channel of the audio signal is two channels, the processor 140 may identify a left side of the identified user position as an audio output position for outputting an audio signal corresponding to an L channel and may identify a right side of the identified user position as an audio output position for outputting an audio signal corresponding to an R channel.

Alternatively, the processor 140 may identify information regarding a position of at least one external device positioned around the projector 100 based on an image around the projector 100 obtained from the image sensor or the distance sensor.

In addition, the projector 100 may set a movement path for at least one external device to move to an operation position based on the map information stored in the memory 120 and the information regarding the position of at least one external device, and may transmit information regarding the movement path to at least one external device. Accordingly, even when at least one movement device does not identify the map information or the position information by itself, at least one movement device may move based on movement-path information provided by the projector 100 and may move to the operation position.

Meanwhile, when content includes a video signal for main content and a video signal for additional content, the processor 140 may identify a projection position for projecting the main content and a projection position for projecting the additional content. In this case, the projection position for projecting the additional content may be a position for projecting the additional content on one side of the main content. However, the present disclosure is not limited thereto.

When the content includes an audio signal, the projector 100 may identify a sound-source position of the audio signal as an audio output position.

Specifically, as described above, the projector 100 may identify an audio output position based on an output channel of an audio signal and a user position. For example, when an audio signal has four channels, the projector 100 may identify, based on a direction in which the user looks, a left side and a right side at a front of the user as an audio output positions, and may identify a left side and a right side at a rear of the user as an audio output positions.

Alternatively, the processor 140 may identify an audio output position based on an output channel of an audio signal and a position of a projection surface. For example, when the audio signal has four channels, the processor 140 may identify, as audio output positions, a left point and a right point of the projection surface among points spaced apart from the projection surface by a predetermined first distance, and may identify, as audio output positions, a left point and a right point of the projection surface among points spaced apart from the projection surface by a predetermined second distance. In this case, the second distance may be greater than the first distance.

When at least one external device moves to an operation position, the processor 140 may control at least one operating device to perform an operating operation.

Here, the operating operation may be an operation required for reproducing content. Specifically, the operating operation may be at least one of an operation of projecting an image or an operation of outputting sound. However, the present disclosure is not limited thereto.

When the operating operation is the operation of projecting an image, the processor 140 may control at least one external device to project one integrated image by interworking with the projector 100. In this case, each of the projector 100 and at least one external device may project a portion of the integrated image.

In this case, the processor 140 may control projection light amounts of the projection unit 110 and at least one external device.

Specifically, the processor 140 may control the projection unit 110 and at least one external device to project an image at a projection light amount corresponding to an illuminance value detected by each device. For example, when an illuminance value detected by a first external device is a first illuminance value, the processor 140 may control the first external device to project an image at a first brightness. In addition, when an illuminance value detected by a second external device is a second illuminance value higher than the first illuminance value, the processor 140 may control the second external device to project an image at a second brightness higher than the first brightness.

Alternatively, when remaining power of the first external device is a first value and remaining power of the second external device is a second value higher than the first value, the processor 140 may control the first external device to project an image at the first brightness and may control the second external device to project an image at the second brightness higher than the first brightness.

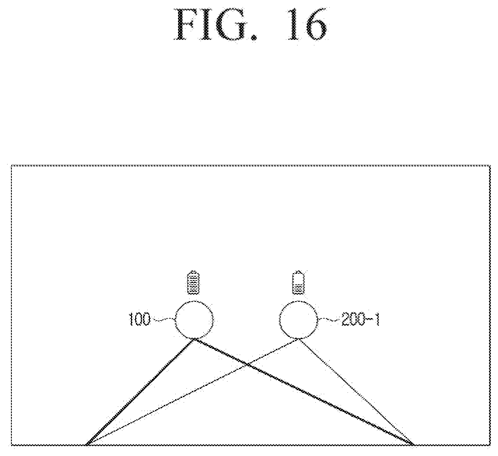

For example, as illustrated in FIG. 16, the processor 140 may control a first external device having remaining power of 50% to project an image at the first brightness and may control a second external device having remaining power of 100% to project an image at the second brightness higher than the first brightness.

In addition, when the operating operation is an operation of outputting audio, the processor 140 may control at least one external device to output an audio signal corresponding to an audio sound-source position.

Specifically, when the audio signal is a multi-channel audio signal, the processor 140 may control an audio output device positioned at a sound-source position corresponding to a first channel among multi-channels to output an audio signal corresponding to the first channel. In addition, the processor 140 may control an audio output device positioned at a sound-source position corresponding to a second channel among the multi-channels to output an audio signal corresponding to the second channel.

For example, when the audio signal is a two-channel audio signal, the processor 140 may control an audio output device positioned at a sound-source position corresponding to an L channel among two channels to output an audio signal corresponding to the L channel. In addition, the processor 140 may control an audio output device positioned at a sound-source position corresponding to an R channel among the two channels to output an audio signal corresponding to the R channel.

In this case, a sound-source position corresponding to a channel of the audio signal may be identified based on a user position. For example, a sound-source position corresponding to the L channel of the audio signal may be positioned on a left side of the user. In addition, a sound-source position corresponding to the R channel of the audio signal may be positioned on a right side of the user.

Meanwhile, the processor 140 may control an audio output direction of the audio output device. Specifically, the processor 140 may control at least one audio output device in such a manner that each of at least one audio output device outputs audio in a direction in which the user is positioned. Accordingly, the processor 140 may provide the user with an immersive audio reproduction experience.

In this case, the processor 140 may detect a user position and may transmit information regarding the user position to at least one audio output device. In addition, based on the received information regarding the user position, at least one audio output device may output audio in the direction in which the user is positioned.

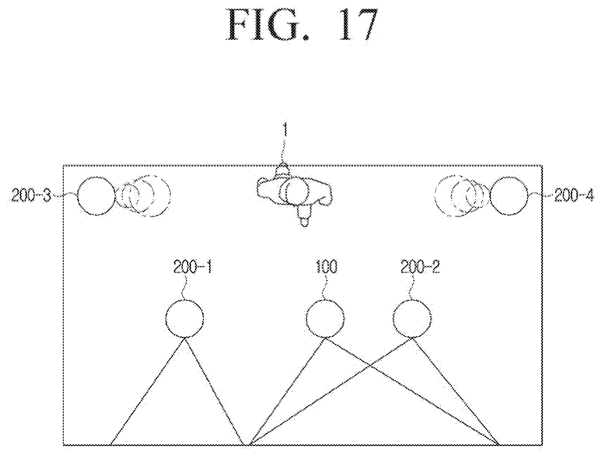

For example, as illustrated in FIG. 17, when the third external device 200-3 and the fourth external device 200-4 are identified as the audio output devices, the processor 140 may control the third external device 200-3 and the fourth external device 200-4 to output audio in a direction in which a user 1 is positioned.

Alternatively, each of at least one audio output device may detect a user position. In addition, based on information regarding the detected user position, at least one audio output device may output audio in the direction in which the user is positioned.

Meanwhile, when a predetermined event occurs while at least one external device performs an operating operation, the processor 140 may adjust the operating operation of at least one external device.

Specifically, the predetermined event may be an event in which state information of at least one external device changes.

According to one or more embodiments, the predetermined event may be an event in which remaining power of at least one device among at least one external device becomes less than a predetermined value.

In this case, the processor 140 may decrease a projection light amount of a device whose remaining power becomes less than the predetermined value among the projector 100 and at least one external device. In addition, the processor 140 may increase a projection light amount of remaining devices among the projector 100 and at least one external device. Accordingly, a projection light amount of an entire projected image may be maintained even when a projection light amount of a device whose remaining power is less than the predetermined value decreases among the projector 100 and at least one external device.

Specifically, while the external device moves to one side of the projector 100 based on a control signal and projects an integrated screen, when remaining power of the external device is less than a predetermined value, the processor 140 may transmit, to the external device, data corresponding to a decrease in a light amount of the external device. That is, when remaining power of the external device decreases to be less than the predetermined value while an integrated screen is projected, the processor 140 may generate a control signal for decreasing the light amount of the external device and may transmit the generated control signal to the external device. In addition, the processor 140 may increase a light amount of the projection unit 110.

Alternatively, while the external device moves to one side of the projector 100 based on a control signal and projects an integrated screen, when remaining power of the projector 100 is less than a predetermined value, the processor 140 may transmit, to the external device, data corresponding to an increase in a light amount of the external device. That is, when remaining power of the projector 100 decreases to be less than the predetermined value while an integrated screen is projected, the processor 140 may transmit, to the external device, a control signal for increasing the light amount of the external device. In addition, the processor 140 may decrease the light amount of the projection unit 110.

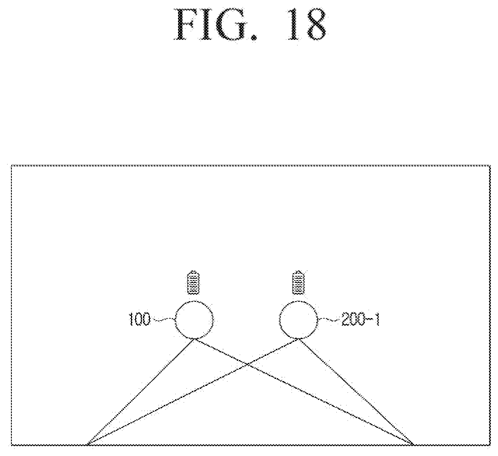

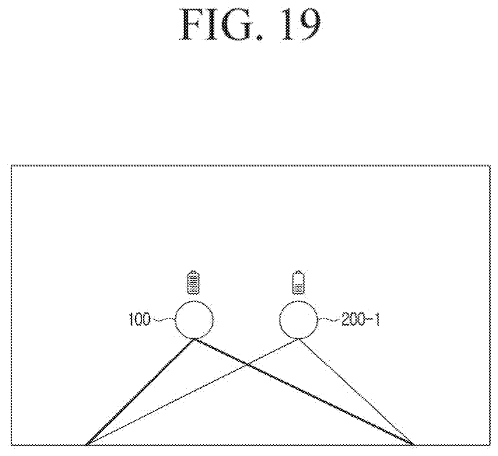

For example, as illustrated in FIG. 18, the projector 100 and the first external device 200-1 may project an image at the first brightness. While the projector 100 and the first external device 200-1 project an image, as illustrated in FIG. 19, when remaining power of the first external device 200-1 becomes less than the predetermined value, the processor 140 may decrease a projection light amount of the first external device 200-1. In addition, the processor 140 may increase a projection light amount of the projector 100.

In this case, a degree to which the projection light amount decreases may correspond to remaining power. For example, when remaining power of the first external device 200-1 is first remaining power, the projector 100 may decrease the projection light amount of the first external device 200-1 to a first projection light amount. In addition, when remaining power of the first external device 200-1 is second remaining power lower than the first remaining power, the projector 100 may decrease the projection light amount of the first external device 200-1 to a second projection light amount lower than the first projection light amount.

In addition, a degree to which the projection light amount increases may correspond to the degree to which the projection light amount decreases. For example, when the projection light amount of the first external device 200-1 decreases to the first projection light amount, the processor 140 may increase a projection light amount of the second external device 200-2 to a third projection light amount. In addition, when the projection light amount of the first external device 200-1 decreases to the second projection light amount lower than the first projection light amount, the projector 100 may increase the projection light amount of the second external device 200-2 to a fourth projection light amount higher than the third projection light amount.

Meanwhile, when remaining power of at least one device among at least one external device becomes less than a predetermined value, the processor 140 may replace positions of a device in a standby state for operation in the device group and a device whose remaining power becomes less than the predetermined value.

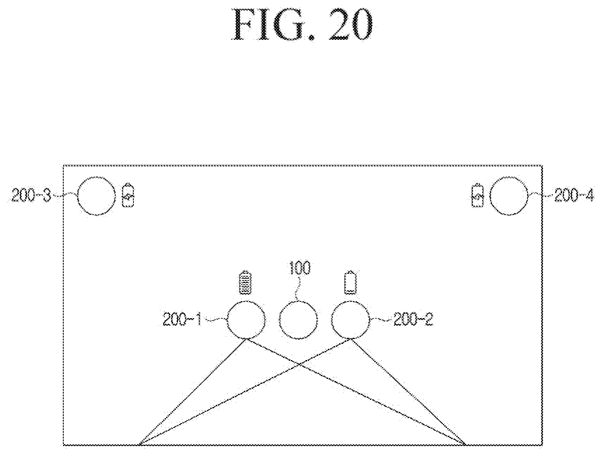

For example, as illustrated in FIG. 20, while the projector 100, the first external device 200-1, and the second external device 200-2 interwork to project an image, remaining power of the second external device 200-2 may become less than the predetermined value. In this case, the third external device 200-3 and the fourth external device 200-4 may be in a standby state for operation. Specifically, the third external device 200-3 and the fourth external device 200-4 may be in a state in which charging is completed or charging is being performed at a charging station.

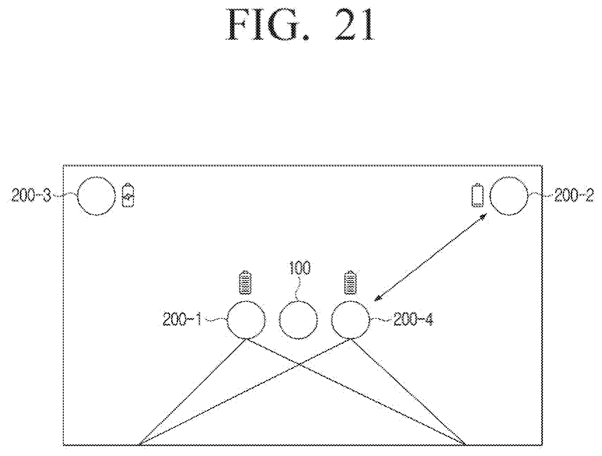

As illustrated in FIG. 21, the processor 140 may control the second external device 200-2 and the fourth external device 200-4 to exchange their positions and may control the fourth external device 200-4 to project an image instead of the second external device 200-2. Accordingly, the second external device 200-2 whose remaining power is less than the predetermined value may be charged at the charging station.

According to one or more embodiments, the predetermined event may refer to an event in which at least one illuminance value among illuminance values detected by at least one operating device becomes less than a predetermined value.

In this case, the processor 140 may increase a projection light amount of a device whose detected illuminance is less than the predetermined value among the projector 100 and at least one external device.

In this case, a degree to which the projection light amount increases may correspond to the detected illuminance. For example, when illuminance detected by the first external device 200-1 is first illuminance less than the predetermined value, the processor 140 may increase the projection light amount of the first external device 200-1 to a first light amount. In addition, when illuminance detected by the first external device 200-1 is second illuminance lower than the first illuminance, the processor 140 may increase the projection light amount of the first external device 200-1 to a second light amount greater than the first light amount.

Accordingly, the projector 100 according to the present disclosure may dynamically control projection light amounts in an environment in which illuminance differs for each of a plurality of projectors, thereby providing a user with a uniform visual experience.

Meanwhile, the predetermined event may be an event in which position movement of a user is detected.

According to one or more embodiments, when a movement of a user position is detected, the projector 100 may identify a tracking device for tracking the user among operating devices.

The processor 140 may detect a user movement through a sensor included in the sensor unit 159. That is, the processor 140 may detect the user movement based on a sensing value obtained from the sensor unit 159. When the user movement is detected in a state in which the processor 140 controls the projection unit 110 to project content, the processor 140 may select, among at least one external device, an external device having a tracking function and a projection function. The processor 140 may transmit, to the selected external device, a control signal for projecting content onto a floor surface along a movement path of the user while tracking the user position.

That is, while content is projected, when the user movement is sensed by a sensor, the processor 140 may transmit, to an external device having the tracking function and the projection function among at least one external device, data for allowing content to be projected onto a floor surface along the movement path of the user whose movement is detected.

Specifically, the projector 100 may identify, as the tracking device, a device having the highest priority for the tracking function among operating devices.

Alternatively, the projector 100 may identify, as the tracking device, an operating device closest to the user among operating devices having the tracking function. For example, when the user moves rightward, an operating device positioned on the right side of the user may be identified as the tracking device. In addition, when the user moves leftward, an operating device positioned on the left side of the user may be identified as the tracking device.

When the tracking device is identified, the projector 100 may control the tracking device to track the user. In this case, while the tracking device tracks the user, the projector 100 may control the tracking device to project at least a portion of content being reproduced on one side of the user.

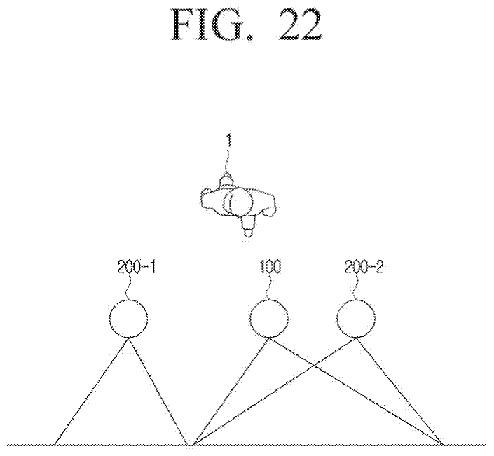

For example, as illustrated in FIG. 22, the projector 100, the first external device 200-1, and the second external device 200-2 may interwork to project an image. In this case, the processor 140 may detect a change in a position of the user 1.

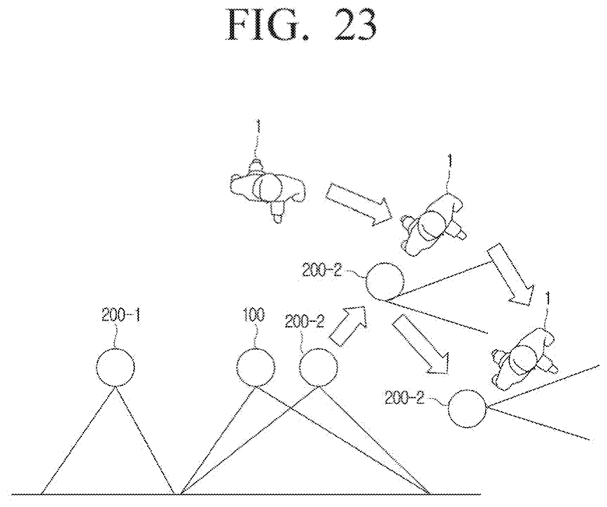

As illustrated in FIG. 23, when the change in the position of the user 1 is detected, the processor 140 may control the second external device 200-2 among the first external device 200-1 and the second external device 200-2 having the highest priority for a tracking function to track the user, the second external device 200-2 being close to a direction of a position movement of the user. In addition, the processor 140 may control the second external device 200-2 to track the user 1 and to project an image onto a floor surface in front of the user based on the movement path of the user 1. In this case, the image may be a predetermined image or may be an image projected by the second external device 200-2.

For example, when content includes a live-view image, the processor 140 may control the second external device 200-2 tracking the user to project the live-view image onto the floor surface along the movement path along which the user moves.

Alternatively, while the tracking device tracks the user, the processor 140 may control the tracking device to output at least a portion of an audio signal included in the content in a direction in which the user is positioned.

Alternatively, when the content includes a video signal and an audio signal and a change in a user position is detected, the processor 140 may change the projection positions and projection surfaces of at least one external device and the projection unit 110 to projection positions and projection surfaces corresponding to the changed user position. In addition, the processor 140 may change an audio output position of at least one audio output device to an audio output position corresponding to the changed user position. That is, the projection position of a projected image and audio output position may be determined based on a channel of the audio signal and the user position.

In this case, the processor 140 may identify the audio output position corresponding to the changed user position and may move at least one audio output device to the identified audio output position.

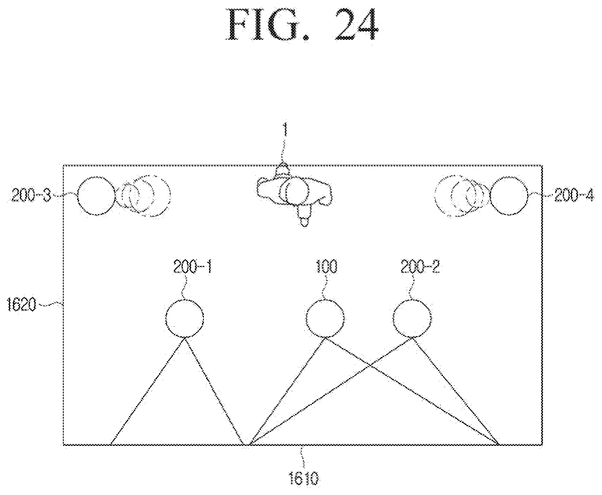

For example, as illustrated in FIG. 24, the projector 100, the first external device 200-1, and the second external device 200-2 may project an image onto a first projection surface 1510 from a first projection position. In this case, the first projection surface 1510 may be a projection surface positioned in a direction in which the user looks. In addition, the first projection position may be a position for projecting an image onto the first projection surface 1510. In addition, the third external device 200-3 and the fourth external device 200-4 may output audio from sound-source positions in a direction in which the user 1 is positioned. In this case, the third external device 200-3 may output an audio signal corresponding to the R channel, and the fourth external device 200-4 may output an audio signal corresponding to the L channel.

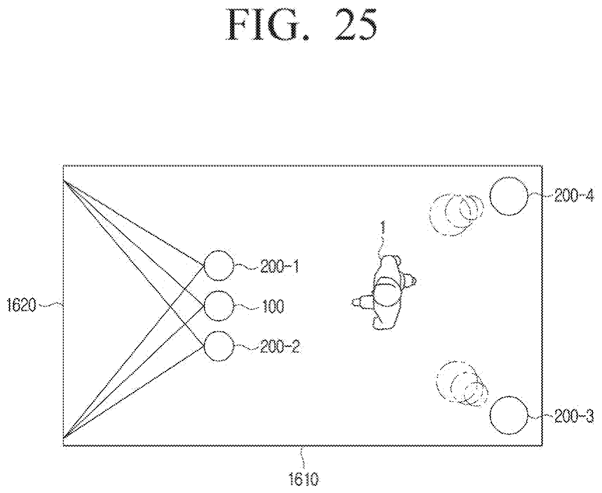

In this case, as illustrated in FIG. 25, when a change in the position of the user 1 is detected, the processor 140 may re-identify the projection position and audio output position corresponding to the changed user position 1. Accordingly, the processor 140 may control the projector 100, the first external device 200-1, and the second external device 200-2 to move to a second projection position and to project an image onto a second projection surface 1620 from the second projection position. In this case, the second projection surface 1620 may be a projection surface positioned in a direction in which the user looks at the changed user position. In addition, the second projection position may be a projection position for projecting an image onto the second projection surface 1620. In addition, the processor 140 may control the third external device 200-3 and the fourth external device 200-4 to output audio from sound-source positions based on the changed user position 1. Specifically, the processor 140 may control the third external device 200-3 and the fourth external device 200-4 to move to the right side and left side of the user 1, respectively, may control the third external device 200-3 to output an audio signal of a channel corresponding to the right side of the user 1, and may control the fourth external device 200-4 to output an audio signal of a channel corresponding to the left side of the user.

Alternatively, the predetermined event may be an event in which a content reproduction environment changes. Specifically, the predetermined event may be an event in which illuminance of a space in which content is reproduced changes.

When the content reproduction environment changes, the processor 140 may re-identify an operating device, an operation position, and an operating operation corresponding to the changed content reproduction environment.

In addition, the processor 140 may control the re-identified operating device to interwork and operate based on the re-identified operating device, operation position, and operating operation.

For example, while one projector projects an image, when illuminance of a space in which the image is projected becomes less than a predetermined value, the processor 140 may identify two additional projectors in the device group, may move the identified two projectors to projection positions, and may control the identified two projectors to project an image.

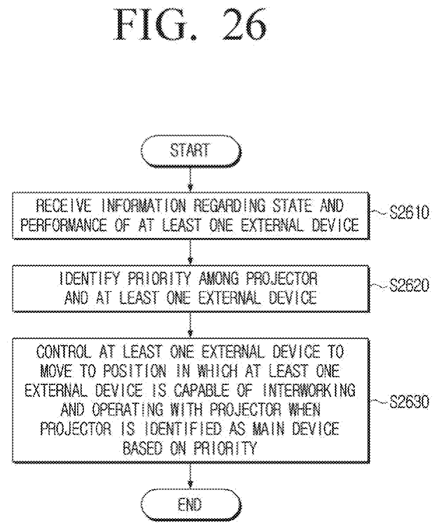

FIG. 26 is a flowchart illustrating a control method of a projector according to one or more embodiments of the present disclosure.

Referring to FIG. 26, when communication with at least one external device is connected, the projector 100 may receive and store information regarding the state and performance of at least one external device (S2610). The projector 100 may also transmit its own information to at least one external device.

The projector 100 may identify a priority among the projector and at least one external device based on the stored information (S2620). A method by which the projector 100 identifies the priority is described in detail in the other embodiments described above, and a redundant description thereof is thus omitted.

The projector 100 may transmit, to at least one external device, data corresponding to position movement in which at least one external device is capable of interworking and operating with the projector 100 when the projector is identified as the main device based on the priority (S2630). That is, the projector 100 may generate a control signal for movement to a position at which at least one external device is able to interwork and operate with the projector 100, and may transmit the generated control signal to at least one external device.

When one of the external devices is identified as the main device, the projector 100 may operate based on a control signal received from the main device. In this case, a method by which the main device controls the projector 100 may be the same as the method by which the projector 100 controls at least one external device in the embodiments described above.

Accordingly, the projector 100 may provide various services, such as projecting content, outputting audio, or the like, together with at least one external device. The services provided by interworking among a plurality of devices are described in detail in the various embodiments described above, and redundant descriptions thereof are thus omitted.

The control method described with reference to FIG. 26 may be performed by the projector 100 described in the various embodiments described above, or may be performed by the external device other than the projector. Alternatively, the control method described with reference to FIG. 26 may be performed by a device having a configuration different from the configuration described in the above embodiments.

Although the various embodiments are described above, the respective embodiments may not necessarily be implemented independently and may be entirely or partially combined with at least one other embodiment to be implemented together in a single product.

According to the various embodiments as described above, the user may be provided with the various services such as viewing content of various sizes by using a plurality of electronic apparatuses, listening to optimized audio, and maintaining content viewing while moving. Accordingly, user satisfaction may be maximized.

Meanwhile, the term “~er/~or” or “module” used in the disclosure may include a unit including hardware, software or firmware, and may be used interchangeably with the term, for example, a logic, a logic block, a component or a circuit. The “~er/~or” or “module” may be an integrally formed component, or a minimum unit or part performing one or more functions. For example, the module may include an application-specific integrated circuit (ASIC).

The various embodiments of the present disclosure may be implemented by software including an instruction stored on a machine-readable storage medium, the instructions being readable by a machine (e.g., a computer). The machine may be a device that invokes the stored instruction from a storage medium, may be operated based on the invoked instruction, and may include the projector 100 according to the disclosed embodiments. When the instruction is executed by the processor, the processor may directly perform, or perform functions corresponding to the instructions by using other components under control of the processor. The instruction may include codes generated or executed by a compiler or an interpreter. The machine-readable storage medium may be provided in the form of a non-transitory storage medium. Here, the term “non-transitory” merely indicates that the storage medium is tangible without including a signal, and does not distinguish whether data are semi-permanently or temporarily stored in the storage medium.

According to one or more embodiments, the method according to the various embodiments disclosed in this document may be provided by being included in a computer program product. The computer program product may be traded as a product between a seller and a buyer. The computer program product may be distributed in the form of a machine-readable storage medium (e.g., a compact disc read only memory (CD-ROM)) or online through an application store (e.g., Play Store™). In the case of online distribution, at least a part of the computer program product may be temporarily stored or generated in a storage medium such as a memory of a manufacturer server, an application store server, or a relay server.

Each of the components (e.g., modules or programs) according to the various embodiments may include a single entity or a plurality of entities, and some of the corresponding sub-components described above may be omitted or other sub-components may be further included in the various embodiments. Alternatively or additionally, some of the components (e.g., the modules or the programs) may be integrated into one entity, and may perform functions performed by the respective corresponding components before integration in the same or similar manner. Operations performed by the modules, the programs or other components according to the various embodiments may be executed in a sequential manner, a parallel manner, an iterative manner or a heuristic manner, at least some of the operations may be performed in a different order or be omitted, or other operations may be added.

What is claimed is:

1. A projection device comprising:
a communication interface;
a projector configured to project content;
memory storing at least one instruction; and
at least one processor operatively connected to the projector, the communication interface, and the memory,
wherein the instructions, when executed by the at least one processor individually or collectively, cause the projection device to:
based on at least one external device being connected to the projection device through the communication interface, identify a priority among the projection device and the at least one external device based on information regarding a state and performance of the at least one external device, and
transmit, to the at least one external device through the communication interface, data corresponding to operation parameters for the at least one external device for an interworking operation with the projection device based on the projection device being identified as a main device based on the priority.

2. The projection device as claimed in claim 1, wherein the instructions, when executed by the at least one processor individually or collectively, cause the projection device to:
transmit, to an external device having a projection function among the at least one external device, data corresponding to movement to one side of the projection device and corresponding to projection of an integrated screen interworking with the projection device.

3. The projection device as claimed in claim 1, wherein the instructions, when executed by the at least one processor individually or collectively, cause the projection device to:
control the projector to project first content, and
transmit, to an external device including a projection function among the at least one external device, data corresponding to projection of additional content related to the first content.

4. The projection device as claimed in claim 1, wherein the at least one external device comprises a plurality of external devices, and
based on the plurality of external devices including a projection function, the instructions, when executed by the at least one processor individually or collectively, cause the projection device to:
control the projector to project first content,
transmit, to at least one external device among the plurality of external devices including the projection function, data corresponding to projection of at least a portion of the first content by interworking with the projection device, and
transmit, to remaining devices among the plurality of external devices including the projection function, data corresponding to projection of additional content related to the first content.

5. The projection device as claimed in claim 1, wherein based on content including an audio signal and a video signal being reproduced, the instructions, when executed by the at least one processor individually or collectively, cause the projection device to:
based on an audio output device being included in the at least one external device, transmit, to an external device including the audio output device, data corresponding to movement of the external device including the audio output device to a sound source position of the audio signal and corresponding to output of the audio signal, and
transmit, to an external device having a projection function among the at least one external device, data corresponding to movement of the external device having the projection function to one side of the projection device and corresponding to output of at least a portion of the video signal by interworking with the projection device.

6. The projection device as claimed in claim 1, wherein the projection device stores, in the memory, information obtained by identifying priority for each function based on information of the projection device and the at least one external device, and
based on content including an audio signal and a video signal being reproduced, the instructions, when executed by the at least one processor individually or collectively, cause the projection device to:
identify a device configured to output the audio signal among the projection device and the at least one external device based on priority for an audio output function, and
identify a device configured to output the video signal among the projection device and the at least one external device based on priority for a projection function.

7. The projection device as claimed in claim 1, further comprising at least one sensor,
wherein the instructions, when executed by the at least one processor individually or collectively, cause the projection device to:
control the projector to project the content, and
based on movement of a user being sensed by the at least one sensor while the content is projected, transmit, to an external device having a tracking function and a projection function among the at least one external device, data for projecting the content onto a floor surface along a movement path of the user whose movement is detected.

8. The projection device as claimed in claim 2, wherein the instructions, when executed by the at least one processor individually or collectively, cause the projection device to:
based on remaining power of the external device being less than a predetermined value while the external device moves to one side of the projection device and projects the integrated screen based on the transmitted data, transmit, to the external device, data corresponding to a decrease of a light amount of the external device, and control the projector to increase a light amount of the projector, and
based on remaining power of the projection device being less than the predetermined value, transmit, to the external device, data corresponding to an increase of a light amount of the external device, and control the projector to decrease the light amount of the projector.

9. The projection device as claimed in claim 1, further comprising an illuminance sensor configured to sense illuminance,
wherein the instructions, when executed by the at least one processor individually or collectively, cause the projection device to:
identify, based on the illuminance and the priority, a number of devices participating in content projection.

10. The projection device as claimed in claim 1, wherein the instructions, when executed by the at least one processor individually or collectively, cause the projection device to:
based on the at least one external device being connected to the projection device through the communication interface, store, in the memory, the information regarding the state and performance of the at least one external device.

11. The projection device as claimed in claim 1, wherein the data corresponding to operation parameters for the at least one external device comprises data on position movement and data on projection operation.

12. A control method of a projection device, the control method comprising:
based on at least one external device being connected to the projection device, identifying priority among the projection device and the at least one external device based on information regarding a state and performance of the at least one external device; and
transmitting, to the at least one external device, data corresponding to operation parameters for the at least one external device for an interworking operation with the projection device based on the projection device being identified as a main device based on the priority.

13. The control method as claimed in claim 12, comprising:
transmitting, to an external device having a projection function among the at least one external device, data corresponding to movement to one side of the projection device and corresponding to projection of an integrated screen interworking with the projection device.

14. The control method as claimed in claim 12, comprising:
controlling a projector of the projection device to project content; and
transmitting, to an external device including a projection function among the at least one external device, data corresponding to projection of additional content related to the content.

15. The control method as claimed in claim 14, wherein based on a plurality of external devices including the projection function being provided, the method comprising:
transmitting, to the at least one external device among the plurality of external devices including the projection function, data corresponding to projection of at least a portion of the content by interworking with the projection device; and
transmitting, to remaining devices among the plurality of external devices including the projection function, the data corresponding to projection of the additional content.

16. The control method as claimed in claim 12, wherein based on content including an audio signal and a video signal being reproduced, the method comprising:
based on an audio output device being included in the at least one external device, transmitting, to an external device including the audio output device, data corresponding to movement to a sound source position of the audio signal and corresponding to output of the audio signal; and
transmitting, to an external device having a projection function among the at least one external device, data corresponding to movement to one side of the projection device and corresponding to output of at least a portion of the video signal by interworking with the projection device.
